(19) United States
(12) Patent Application Publication
(10) Pub. No.: US 2026/0135697 A1
(43) Pub. Date: May 14, 2026

(54) NON-TRANSITORY COMPUTER-READABLE MEDIUM, APPARATUS FOR STORING CONFIGURATION DATA OF A TARGET SEMICONDUCTOR DEVICE AND APPARATUS FOR PERFORMING A COLD BOOT SEQUENCE ON A SEMICONDUCTOR DEVICE

(71) Applicants: Miraben PATEL, Folsom, CA (US); Ingrid MURPHY, San Jose, CA (US); Kamraan NASIM, Folsom, CA (US); Daniel APPERLOO, Delta (CA); Avi MORALI, Modiin Macabim Reut (IL); Allen GARDINER, Portland, OR (US); Sreenadh KARETI, Fremont, CA (US); Pawan CHHABRA, Bangalore (IN); Anthony GIARDINA, Colfax, CA (US); Marian CRETU, Santa Clara, CA (US); Marcus WINSTON, Aloha, OR (US); Biju Neerthattil SUDHAKARAN, Bangalore (IN); Sean DARDIS, Forest Grove, OR (US); Pratap PRASAD, Santa Clara, CA (US); Sreeja MENON, Delhi (IN); Joaquin ROMERA, San Diego, CA (US)

(72) Inventors: Miraben PATEL, Folsom, CA (US); Ingrid MURPHY, San Jose, CA (US); Kamraan NASIM, Folsom, CA (US); Daniel APPERLOO, Delta (CA); Avi MORALI, Modiin Macabim Reut (IL); Allen GARDINER, Portland, OR (US); Sreenadh KARETI, Fremont, CA (US); Pawan CHHABRA, Bangalore (IN); Anthony GIARDINA, Colfax, CA (US); Marian CRETU, Santa Clara, CA (US); Marcus WINSTON, Aloha, OR (US); Biju Neerthattil SUDHAKARAN, Bangalore (IN); Sean DARDIS, Forest Grove, OR (US); Pratap PRASAD, Santa Clara, CA (US); Sreeja MENON, Delhi (IN); Joaquin ROMERA, San Diego, CA (US)

(21) Appl. No.: 19/389,149

(22) Filed: Nov. 14, 2025

(51) Int. Cl. H04L 9/08; G06F 13/28; H04L 9/06

(52) U.S. Cl. CPC H04L 9/0866; G06F 13/28; H04L 9/0656

(57) ABSTRACT

It is provided a non-transitory computer-readable medium storing instructions that, when executed by one or more processing circuitries of an apparatus, causing the one or more processing circuitries to perform locally on the apparatus a method. The method includes receiving configuration inputs for a target semiconductor device, the configuration inputs comprising a device identifier, one or more safety-critical parameters, and profile-specific operational parameters for one or more semiconductor device configuration profiles. The method further includes generating a first set of configuration data for programming into a non-volatile one-time programmable memory of the target semiconductor device. The method further includes generating a second set of configuration data for a non-volatile rewritable memory of the target semiconductor device.

### BACKGROUND

Semiconductor devices may require configuration data to establish operational parameters, performance characteristics, and feature enablements. Configuration data may define aspects such as processing frequencies, power budgets, thermal limits, and enabled functional units. Different product variants of semiconductor devices may require different configuration parameters to support market segmentation, performance tiers, and regulatory compliance requirements. The storage and management of configuration data may involve trade-offs between security, flexibility, and manufacturing efficiency. Immutable storage mechanisms may provide security benefits by preventing unauthorized modifications but may limit flexibility for post-manufacturing adjustments. Rewritable storage mechanisms may provide flexibility for updates and corrections but may present security challenges related to unauthorized access or transfer of configuration data between devices. There may be a need for configuration systems that balance security requirements with manufacturing flexibility while preventing unauthorized configuration transfers and supporting efficient device initialization during boot sequences.

### BRIEF DESCRIPTION OF THE FIGURES

Some examples of apparatuses and/or methods will be described in the following by way of example only, and with reference to the accompanying figures, in which

FIG. 1 illustrates a block diagram of an example of a non-transitory computer-readable medium;

FIG. 2 illustrates a block diagram of an example of an apparatus;

FIG. 3 illustrates a flowchart of an example of a method;

FIG. 4 illustrates an apparatus for storing configuration data of a target semiconductor device;

FIG. 5 illustrates an example system for generating configuration data for a semiconductor device;

FIG. 6 illustrates an apparatus performing a cold sequence of a semiconductor device;

FIG. 7 illustrates a flowchart of an example of a method for performing a cold boot sequence on a semiconductor device;

FIGS. 8A-8D illustrate an example flow for a cold boot sequence of the semiconductor device;

FIG. 9 illustrates an apparatus performing a warm reset exit of a semiconductor device;

FIG. 10 illustrates a flowchart of an example of a method for performing a warm reset exit on a semiconductor device;

FIGS. 11A-11D illustrate an example flow for a warm reset exit sequence of a semiconductor device with AON (always-on) retention; and

FIG. 12 illustrates an example of a block diagram of an electronic apparatus.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform, or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

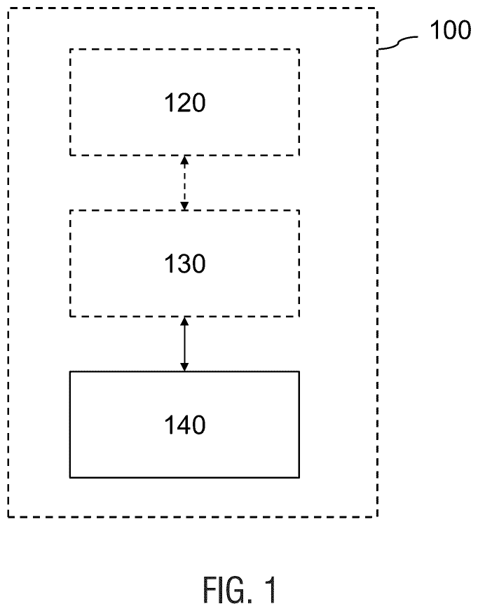

FIG. 1 illustrates a block diagram of an example of a non-transitory computer-readable medium 140. The non-transitory computer-readable medium 140 stores instructions that, when executed by a processing circuitry 130 of an apparatus 100, causes the processing circuitry 130 to perform locally on the apparatus 100, a method (such as method 300). The processing circuitry 130 may access the non-transitory computer-readable medium 140 via an interface circuitry 120. In some examples, the non-transitory computer-readable medium 140 may be included in an apparatus 100, which may also comprise the processing circuitry 130. In some examples, the processing circuitry 130 may be distributed over a plurality of apparatuses and may, for example, access the non-transitory computer-readable medium 140 via the interface circuitry 120.

For example, the non-transitory computer-readable medium may refer to any tangible, physical medium capable of storing instructions, data, or other types of information for access by a computer, processor, or similar electronic device. The computer-readable medium may be non-transitory in that medium may have a persistent or enduring form. The non-transitory computer-readable medium may comprise one or more of the following computer-readable mediums: magnetic storage devices, such as hard disk drives (HDDs) and magnetic tapes, which store data using magnetic patterns and are commonly used for long-term data storage in computers, servers, and backup systems. Optical storage media, including compact discs (CDs), digital versatile discs (DVDs), and Blu-ray discs, utilize laser technology to read and write data, offering durability and longevity for storing software, media, and backups. More modern forms include solid-state devices (SSD), which rely on flash memory technology without moving parts, such as USB flash drives, secure digital (SD) cards, and internal/external SSDs, valued for their fast read/write speeds and portability. Additionally, non-volatile memory chips like read-only memory (ROM) and programmable ROM (PROM) store critical firmware or embedded software, commonly found in embedded systems and computers. Advanced memory technologies, such as phase-change memory (PCM), magnetoresistive RAM (MRAM), and ferroelectric RAM (FeRAM), offer persistent data storage with high reliability, speed, and power efficiency, making them ideal for applications requiring rapid access and data retention, such as in mobile devices, high-performance computing, and industrial systems.

For example, the processing circuitry 130 may access the non-transitory computer-readable medium 140 over the interface circuitry 120 of the apparatus 100. For example, the processing circuitry 130 may then execute the instructions stored on the non-transitory computer-readable medium 140 of the apparatus 100. The execution of the instructions stored on the non-transitory computer-readable medium 140 causes the processing circuitry 130 to perform locally on the apparatus 100 the method.

The method comprises receiving configuration inputs for a target semiconductor device. The target semiconductor device may be a semiconductor component that is being configured with operational parameters and settings. The target semiconductor device may be a device that requires configuration data to define its operational characteristics, performance parameters, and functional behavior. For example, the target semiconductor device may comprise at least one of a System-on-a-Chip (SoC), a discrete graphics processing unit (dGPU), a central processing unit (CPU), or an accelerator. The target semiconductor device may be any of these semiconductor component types that require configuration data to define operational parameters and functional characteristics. The SoC may integrate multiple functional blocks and processing elements onto a single chip, including processors, memory controllers, and various peripheral interfaces. The dGPU may be a standalone graphics processing component designed for parallel processing and graphics rendering tasks. The CPU may be a general-purpose processor that executes instructions and manages system operations. The accelerator may be a specialized processing unit optimized for specific computational tasks such as artificial intelligence processing, cryptographic operations, or signal processing.

For example, the target semiconductor device may require configuration parameters based on its specific functionality and operational requirements. An SoC may require configuration inputs that address multiple integrated subsystems and their interactions. A dGPU may require configuration inputs focused on graphics processing capabilities, memory bandwidth, and rendering features. A CPU may require configuration inputs related to core counts, frequency scaling, and power management. An accelerator may require configuration inputs tailored to the specific acceleration function the accelerator performs. For example, the configuration inputs may be received for a dGPU that will be deployed in a workstation environment, where the configuration inputs specify performance parameters appropriate for professional graphics workloads.

The configuration inputs may be data that defines how the target semiconductor device is to operate. This may comprise settings that control one or more aspects of the target semiconductor device's functionality, performance levels, and/or feature enablements. The configuration inputs comprise a device identifier, one or more safety-critical parameters, and profile-specific operational parameters for one or more semiconductor device configuration profiles.

The device identifier may be to a unique identifier that distinguishes the target semiconductor device from other semiconductor devices. The device identifier may serve to uniquely identify a specific physical instance of the target semiconductor device. The device identifier may be used to bind configuration data to a particular target semiconductor device to prevent unauthorized transfer or reuse of configuration data across different physical devices. For example, the device identifier may be a hardware-based unique identifier that is derived from or stored in physical characteristics or hardware elements of the target semiconductor device. A hardware-based unique identifier may provide a high level of security because the hardware-based unique identifier may be difficult or impossible to clone or transfer between different physical devices. The device identifier may comprise at least one of a PCIe device identifier, a fused serial number, a Media Access Control (MAC) address, or an identifier derived from a Physical Unclonable Function (PUF). A PCle device identifier may be a standardized identifier used in Peripheral Component Interconnect Express interfaces that identifies the device type and manufacturer. A fused serial number may be a unique number permanently programmed into the target semiconductor device by burning fuses during manufacturing. A MAC address may be a unique identifier assigned to network interfaces of the target semiconductor device. An identifier derived from a PUF may be generated based on intrinsic physical variations in the semiconductor manufacturing process that are unique to each individual device and practically impossible to duplicate. For example, the configuration inputs may include an identifier derived from a PUF of an SoC, where the identifier is generated based on manufacturing variations in transistor threshold voltages that are unique to that particular SoC, and the identifier may serve as the device identifier to bind subsequent configuration data to that specific SoC.

The safety-critical parameters may be configuration parameters that define operational limits that protect the target semiconductor device from unsafe operating conditions. The one or more safety-critical parameters may establish boundaries within which the target semiconductor device must operate to ensure reliable and safe functionality. The safety-critical parameters may be distinguished from other configuration parameters by the critical nature of the safety-critical parameters in preventing hardware damage, ensuring device longevity, and maintaining operational integrity of the target semiconductor device. For example, the safety-critical parameters may define maximum allowable values or threshold limits that should not be exceeded during operation of the target semiconductor device. The safety-critical parameters may be determined based on physical characteristics and limitations of the semiconductor materials, circuit designs, and thermal properties of the target semiconductor device.

For example, the safety-critical parameters may comprise at least one of a maximum hardware operational frequency, a maximum operational voltage, a maximum thermal threshold, or permanent disablement data for one or more hardware blocks. A maximum hardware operational frequency may be a highest clock frequency at which the target semiconductor device can safely operate without risking timing violations or circuit failures. A maximum operational voltage may be a highest supply voltage that can be applied to the target semiconductor device without causing electrical stress or breakdown of transistors and interconnects. A maximum thermal threshold may be a highest temperature that the target semiconductor device can reach before thermal damage or performance degradation occurs. Permanent disablement data for one or more hardware blocks may be information that permanently deactivates defective or non-functional circuit blocks within the target semiconductor device.

For example, the configuration inputs may include a maximum hardware operational frequency of 2.5 GHz for a CPU, ensuring that the CPU does not operate beyond a frequency that would cause timing failures in critical paths. For example, the configuration inputs may include a maximum operational voltage of 1.2 volts for a dGPU to prevent gate oxide breakdown in transistors. For example, the configuration inputs may include permanent disablement data that deactivates two defective processing cores in an SoC that failed testing during manufacturing, preventing the defective cores from being accessed during operation.

The comprise profile-specific operational parameters for one or more semiconductor device configuration profiles may be configuration parameters that define operational characteristics for specific variants (such as product variants, market segments, or use cases) of the target semiconductor device. The profile-specific operational parameters may distinguish different versions or configurations of the same underlying hardware platform of the target semiconductor device. The semiconductor device configuration profiles may represent different operational modes (such as different product tiers, or deployment scenarios) that require different capabilities (such as performance levels, feature sets) from the target semiconductor device. For example, the profile-specific operational parameters may define actual operating points and enabled features that fall within the boundaries established by the safety-critical parameters. The profile-specific operational parameters may be more flexible and changeable compared to the safety-critical parameters, allowing for product differentiation and market segmentation.

For example, the profile-specific operational parameters may comprise at least one of a product-specific operational frequency that is constrained by a corresponding safety-critical maximum hardware operational frequency, a power budget, a number of enabled processing cores or execution units, a feature enablement flag, or an export-control parameter. A product-specific operational frequency may be an operating clock frequency set for a particular product variant of the semiconductor device that remains below the maximum hardware operational frequency established in the first set of configuration data. The product-specific operational frequency may define the clock speed at which processing elements, graphics engines, or other functional blocks of the semiconductor device operate during normal use. A power budget may be an allocated power consumption limit for the semiconductor device in a specific configuration, constraining how much electrical power the semiconductor device can consume during operation. A number of enabled processing cores or execution units may specify how many computational elements within the semiconductor device are active and accessible in a particular product variant. The processing cores may be CPU cores within a CPU or SoC, while execution units may be parallel processing elements within a dGPU or graphics processor. A feature enablement flag may indicate whether specific functional capabilities or features of the semiconductor device are activated or deactivated, such as hardware acceleration features, security capabilities, or specialized instruction sets. An export-control parameter may specify operational restrictions imposed for compliance with export regulations in certain geographic regions, such as frequency limits, core count restrictions, or disabled features required for products shipped to restricted countries.

For example, a mid-tier dGPU variant may have a product-specific operational frequency of 1.8 GHz while a high-tier variant of the same underlying hardware may have a product-specific operational frequency of 2.2 GHz, both constrained by a maximum hardware operational frequency of 2.5 GHz stored in the first set of configuration data. For example, a server CPU may have 64 processing cores physically present on the die, but a product variant for the workstation market may have a number of enabled processing cores set to 32, effectively disabling half of the cores to create product differentiation. For example, an export-control parameter for a dGPU destined for a restricted geographic region may limit the product-specific operational frequency to 1.5 GHZ and set the number of enabled execution units to 75% of the total available execution units on the semiconductor device.

For example, the target semiconductor device may comprise a plurality of memory for storing configuration data with different characteristics and purposes. The target semiconductor device may comprise both a non-volatile one-time programmable (OTP) memory and a non-volatile rewritable memory that serve complementary roles in configuring the target semiconductor device. The non-volatile OTP memory may store configuration data that remains permanently fixed and immutable throughout the operational lifetime of the target semiconductor device. The non-volatile rewritable memory may store configuration data that may be updated or modified within certain constraints and lifecycle stages. The combination of the non-volatile OTP memory and the non-volatile rewritable memory may provide a hybrid configuration architecture that balances security, flexibility, and operational requirements (see below).

In some examples, the non-volatile OTP memory and the non-volatile rewritable memory may be physically separate memory structures within or associated with the target semiconductor device. The non-volatile OTP memory may be integrated directly onto the semiconductor die of the target semiconductor device as part of the manufacturing process. The non-volatile rewritable memory may be implemented as an external flash memory device connected to the target semiconductor device through a serial peripheral interface or similar communication interface. In some examples, the non-volatile rewritable memory may be integrated onto the same package or module as the target semiconductor device. The configuration data stored in the non-volatile OTP memory and the non-volatile rewritable memory may work together to define the complete operational configuration of the target semiconductor device.

For example, the apparatus 100 may be part of and/or implement a configuration generation tool that receives the configuration inputs for the target semiconductor device. The non-transitory computer-readable medium 140 may store instructions that define how the processing circuitry 130 receives, validates, and processes the configuration inputs. The processing circuitry 130 of the apparatus 100 may execute the instructions from the non-transitory computer-readable medium 140 to collect and process the configuration inputs according to predefined procedures and rules stored on the non-transitory computer-readable medium 140. The configuration inputs may be provided to the apparatus 100 through the interface circuitry 120, which may receive the configuration inputs from various sources including device manufacturers, system integrators, or original equipment manufacturers who need to specify particular operational characteristics for the target semiconductor device. The configuration inputs may encompass a wide range of parameters that collectively define the operational profile and capabilities of the target semiconductor device.

For example, the non-transitory computer-readable medium 140 may store instructions that control how the apparatus 100 provides a graphical user interface through which users input the configuration parameters. The processing circuitry 130 may execute instructions from the non-transitory computer-readable medium 140 to validate and organize the configuration inputs received through the interface circuitry 120. The configuration inputs may be prepared by the apparatus 100 during a pre-manufacturing phase or during the manufacturing process itself. The apparatus 100 may generate configuration data that will subsequently be programmed into the non-volatile OTP memory and the non-volatile rewritable memory of the target semiconductor device at a manufacturing facility or during a post-manufacturing configuration stage. The apparatus 100 may determine which configuration parameters should be included in configuration data for the non-volatile OTP memory and which configuration parameters should be included in configuration data for the non-volatile rewritable memory based on the characteristics and security requirements of the configuration parameters.

For example, the apparatus 100 may receive configuration inputs through the interface circuitry 120 from a system integrator who specifies desired frequency settings, power budgets, and feature enablements for a dGPU serving as the target semiconductor device, and the processing circuitry 130 may execute instructions stored on the non-transitory computer-readable medium 140 to process these configuration inputs and partition the configuration inputs into appropriate configuration data sets for programming into the non-volatile OTP memory and the non-volatile rewritable memory during the manufacturing of the dGPU.

The method further comprises generating a first set of configuration data for programming into the non-volatile OTP memory of the target semiconductor device. The non-volatile OTP memory may be a type of memory that retains stored data without requiring power and can only be programmed once. The non-volatile OTP memory may implement permanent, irreversible storage where data, once written, cannot be modified or erased. The non-volatile character of the OTP memory ensures that stored data persists even when power is removed from the target semiconductor device. The one-time programmable character of the OTP memory ensures that configuration data cannot be altered after initial programming.

For example, the non-volatile OTP memory may be implemented using various physical mechanisms that create permanent changes in the semiconductor structure. The non-volatile OTP memory may comprise electrical fuses (e-fuses) that are irreversibly blown by passing high current through fusible links, creating permanent open circuits that represent a programmed state. The non-volatile OTP memory may comprise antifuses that are initially insulating but become permanently conductive when a high voltage is applied, creating permanent low-resistance connections that represent a programmed state. The non-volatile OTP memory may comprise programmable read-only memory (PROM) cells that use charge trapping mechanisms to create permanent charge storage states. The non-volatile OTP memory may comprise metal fuses that are physically destroyed by high current, creating permanent breaks in conductive paths. The non-volatile OTP memory may be fabricated as part of the target semiconductor device during manufacturing, occupying dedicated areas of the semiconductor die.

The first set of configuration data comprising the safety-critical parameters and the device identifier. In other words, the first set of configuration data may contain the parameters that define fundamental operational limits and unique identification of the target semiconductor device. The safety-critical parameters may be included in the first set of configuration data because the safety-critical parameters establish boundaries that remain fixed to protect the target semiconductor device from damage or unsafe operation. The device identifier may be included in the first set of configuration data to establish a permanent, unforgeable identity for the target semiconductor device. The immutable nature of the non-volatile OTP memory may provide security by preventing unauthorized modification of the safety-critical parameters that could otherwise allow the target semiconductor device to be operated beyond safe limits. The permanent character of the non-volatile OTP memory may provide authentication by ensuring that the device identifier cannot be altered or cloned, which enables binding of other configuration data to the specific physical instance of the target semiconductor device. The use of the non-volatile OTP memory for the first set of configuration data may prevent attacks where an adversary might attempt to increase performance limits or transfer configuration data between different physical devices.

For example, the first set of configuration data may include a maximum hardware operational frequency of 3.0 GHz programmed into e-fuses of a dGPU, where the permanent nature of the e-fuses prevents unauthorized overclocking attempts. For example, the first set of configuration data may include a device identifier comprising a PCIe device identifier and a unique serial number programmed into antifuse memory of an SoC, where the permanent nature of the antifuse memory ensures that the device identifier cannot be altered to masquerade as a different device.

The method further comprises generating a second set of configuration data for a non-volatile rewritable memory of the target semiconductor device. The non-volatile rewritable memory may be a type of memory that retains stored data without requiring power but can be erased and reprogrammed multiple times. The non-volatile rewritable memory may allow configuration data to be updated or modified during certain phases of the device lifecycle while still maintaining data persistence when power is removed. The rewritable character of the non-volatile rewritable memory distinguishes the non-volatile rewritable memory from the non-volatile OTP memory by allowing flexibility in configuration updates.

For example, the non-volatile rewritable memory may be implemented using various memory technologies that support multiple program and erase cycles. The non-volatile rewritable memory may comprise flash memory that stores data in floating-gate transistors and can be electrically erased and reprogrammed in blocks or pages. The non-volatile rewritable memory may comprise EEPROM (Electrically Erasable Programmable Read-Only Memory) that allows byte-level erasure and reprogramming. The non-volatile rewritable memory may comprise NAND flash memory organized in pages and blocks, commonly used in solid-state drives and embedded storage systems. The non-volatile rewritable memory may comprise NOR flash memory that provides random access capabilities and is often used for code storage and execution. The non-volatile rewritable memory may be connected to the target semiconductor device through a serial peripheral interface (SPI), an inter-integrated circuit (12C) interface, or other communication protocols. The non-volatile rewritable memory may be implemented as a separate physical component external to the semiconductor die of the target semiconductor device.

The second set of configuration data comprises the profile-specific operational parameters for a specific device configuration profile, a cryptographic signature and a manifest. The second set of configuration data may contain parameters that define the operational characteristics for a particular product variant or market segment. The profile-specific operational parameters may be included in the second set of configuration data because the profile-specific operational parameters may need to be set or adjusted after initial device manufacturing to support product differentiation, market segmentation, or post-manufacturing configuration. The rewritable nature of the non-volatile rewritable memory may provide flexibility by allowing the profile-specific operational parameters to be programmed or updated during later manufacturing stages, quality assurance testing, or product customization processes. The use of the non-volatile rewritable memory for the second set of configuration data may enable scenarios where different configuration profiles can be applied to physically identical devices to create different product variants without requiring separate manufacturing processes for each variant. The cryptographic signature and the manifest may provide security mechanisms to protect the integrity and authenticity of the second set of configuration data despite the rewritable nature of the storage medium.

For example, the second set of configuration data may include profile-specific operational parameters for a mid-tier dGPU variant with 48 enabled execution units and a product-specific operational frequency of 2.0 GHz, stored in a SPI flash memory connected to the dGPU. For example, the second set of configuration data may include profile-specific operational parameters for a server-grade CPU variant with specific power budget settings and feature enablement flags, stored in a NAND flash memory chip integrated into the CPU package.

The cryptographic signature may be a mathematical value or data structure that provides authentication and integrity protection for the second set of configuration data. The cryptographic signature may be generated using cryptographic algorithms that create a signature value based on the content of the data being signed and a secret cryptographic key. The cryptographic signature may allow verification that the second set of configuration data has not been modified since the cryptographic signature was created and that the second set of configuration data originated from an authorized source possessing the secret cryptographic key.

For example, the cryptographic signature may be calculated based on at least parts of the profile-specific operational parameters and/or at least parts of the manifest. The calculation of the cryptographic signature may comprise applying a cryptographic signing algorithm to the at least part of the profile-specific operational parameters and/or the at least part of the manifest to produce a signature value that is uniquely tied to the content of the profile-specific operational parameters and/or the manifest. The cryptographic signature may be generated using a private key that is kept secure by an authorized entity such as the semiconductor device manufacturer. The cryptographic signature may be verified using a corresponding public key that may be available to the target semiconductor device or embedded within the target semiconductor device. The verification process may allow the target semiconductor device to confirm that the second set of configuration data was created by an authorized entity and has not been tampered with during storage or transmission. The cryptographic signature may protect against attacks where an adversary attempts to modify the profile-specific operational parameters to gain unauthorized capabilities or transplant configuration data between different devices.

For example, the cryptographic signature may be an extended Merkle Signature Scheme (XMSS). XMSS may be a hash-based signature scheme that provides security even against attacks by quantum computers. XMSS may use hash functions and Merkle trees to create signatures that can be verified using public keys. XMSS may be particularly suitable for embedded systems and semiconductor devices where long-term security is important and where resistance to future cryptographic threats is valuable. XMSS may provide stateful signature generation where each message is signed with a different one-time signature key derived from a hash-based key tree structure.

For example, the apparatus 100 may generate the cryptographic signature by executing instructions stored on the non-transitory computer-readable medium 140 that implement an XMSS signing algorithm, where the processing circuitry 130 computes the cryptographic signature over the profile-specific operational parameters and/or the manifest using a private XMSS key stored securely within the apparatus 100. For example, the cryptographic signature may be calculated by hashing the profile-specific operational parameters and the manifest together and then signing the resulting hash value using XMSS to produce a signature that can be verified by the target semiconductor device using a public XMSS key.

The manifest is configured to bind the second set of configuration data to the device identifier and to enforce immutability of the second set of configuration data upon the target semiconductor device reaching a predefined lifecycle state. The manifest may be a data structure that contains metadata (such as binding information or policy directives) associated with the second set of configuration data. The manifest may serve as a header or descriptor that accompanies the profile-specific operational parameters. For example, the manifest provide information about how the second set of configuration data should be validated, authenticated, and applied by the target semiconductor device. The manifest may be generated by the processing circuitry 130 during the process of creating the second set of configuration data. The processing circuitry 130 may execute instructions from the non-transitory computer-readable medium 140 to construct the manifest based on the configuration inputs and security policies applicable to the second set of configuration data.

For example, the manifest may be configured to bind the second set of configuration data to the device identifier. The binding may create a cryptographic or logical association between the second set of configuration data and the specific device identifier of the target semiconductor device for which the second set of configuration data was generated. The binding may be implemented through a mechanism that ties the second set of configuration data to the particular target semiconductor device. The binding may prevent the second set of configuration data from being transplanted or transferred to a different target semiconductor device with a different device identifier. The binding may protect against attacks where an adversary extracts the second set of configuration data from one target semiconductor device and attempts to apply the second set of configuration data to another target semiconductor device to gain unauthorized capabilities or bypass product segmentation controls.

For example, the manifest may be configured to enforce immutability of the second set of configuration data upon the target semiconductor device reaching a predefined lifecycle state. The predefined lifecycle state may be an End-of-Manufacturing (EOM) state that marks the completion of manufacturing and testing processes. The EOM state may represent a transition point where the target semiconductor device moves from a manufacturing environment where configuration updates are permitted to a deployed state where configuration updates should be prevented. The enforcement of immutability may mean that after the target semiconductor device reaches the predefined lifecycle state, the second set of configuration data stored in the non-volatile rewritable memory should no longer be updatable or modifiable through firmware update mechanisms or other in-band update tools.

For example, the manifest may contain information that enables the target semiconductor device to determine whether updates to the second set of configuration data should be permitted based on the current lifecycle state. The manifest may include lifecycle state indicators, flags, or markers that specify the lifecycle stage for which the second set of configuration data was prepared. The target semiconductor device may compare the lifecycle state information in the manifest against the current lifecycle state of the target semiconductor device, which may be tracked through separate lifecycle management mechanisms or stored in the non-volatile OTP memory. Firmware or hardware components of the target semiconductor device may read the lifecycle state information from the manifest and enforce policies that block write operations to the non-volatile rewritable memory containing the second set of configuration data when the lifecycle state indicates that the EOM state has been reached. The enforcement may be implemented through access control mechanisms that prevent update tools, firmware interfaces, or other software components from modifying the second set of configuration data after the EOM state is set.

For example, the enforcement mechanism may transform the rewritable nature of the non-volatile rewritable memory into effectively permanent storage once the EOM state is reached. In some examples, the transformation may occur without physically changing the memory technology but through policy enforcement at the firmware or hardware level. The approach may provide security properties similar to the non-volatile OTP memory while maintaining flexibility during earlier manufacturing and testing phases. During pre-EOM phases, the second set of configuration data may be updated multiple times to accommodate testing iterations, configuration refinements, or corrections. Once the EOM state is set, the same physical memory becomes functionally immutable through the enforcement mechanisms guided by the manifest.

For example, the manifest may include an EOM lock indicator that firmware of a dGPU checks before allowing any write operations to the flash memory region containing the second set of configuration data, where the firmware blocks all write attempts if the EOM lock indicator is set and the target semiconductor device has reached the EOM state. For example, the target semiconductor device may store an EOM state bit in the non-volatile OTP memory, and the manifest may include an epoch value that must match the current device epoch, where firmware prevents updates to the second set of configuration data when the EOM state bit is set, effectively making the second set of configuration data immutable despite residing in rewritable flash memory.

For example, the method described above allows flexible product differentiation and market segmentation while maintaining strong security guarantees against configuration tampering and unauthorized feature unlocking. The method may enable manufacturers to program safety-critical parameters and device identifiers into immutable non-volatile OTP memory while storing profile-specific operational parameters in rewritable non-volatile memory, providing the flexibility to adjust configurations during manufacturing and testing phases without the material costs and time delays associated with re-manufacturing devices with incorrect fuse settings. The method may provide protection against transplant attacks where configuration data is extracted from one device and applied to another device by cryptographically binding the second set of configuration data to the unique device identifier through the manifest. The method may enable post-silicon feature improvements and configuration refinements without being constrained by hardware fuse limitations that can only be programmed once. The method may allow the same physical hardware to be configured into different product variants with different performance levels, enabled features, and export control restrictions by applying different profile-specific operational parameters while maintaining common safety-critical boundaries. The method may provide lifecycle-aware security by enforcing immutability of the second set of configuration data after the EOM state is reached, preventing unauthorized modifications in deployed systems while permitting necessary updates during manufacturing. The method may enable integration of both manufacturer-specified profile-specific operational parameters and OEM-specified system-level operational parameters with distinct security policies appropriate to each source, supporting customization throughout the supply chain.

For example, the method may further comprise transmitting the generated first set of configuration data to a programming interface for the non-volatile OTP memory. The method may further comprise transmitting the generated second set of configuration data to a programming interface for the non-volatile rewritable memory. The programming interface for the non-volatile OTP memory may be a hardware and/or software interface that accepts configuration data and programs the configuration data into the non-volatile OTP memory by executing fuse blowing operations or other one-time programming processes. The programming interface for the non-volatile rewritable memory may be a hardware or software interface that accepts configuration data and writes the configuration data into the non-volatile rewritable memory through write operations appropriate to the memory technology such as flash programming sequences. The transmitting may occur through the interface circuitry 120 of the apparatus 100, which may communicate with programming equipment, test systems, or the target semiconductor device itself during manufacturing processes.

For example, the transmission of the two sets of configuration data to programming interfaces may enable the apparatus 100 to coordinate the programming of both memory types during manufacturing workflows. The apparatus 100 may transmit the first set of configuration data to programming equipment that has access to fuse programming circuitry of the target semiconductor device, where the programming equipment applies high voltages or currents necessary to permanently program the non-volatile OTP memory. The apparatus 100 may transmit the second set of configuration data to programming equipment or firmware update tools that can write to the non-volatile rewritable memory through standard communication protocols such as SPI, 12C, or other serial interfaces. The separate transmission to distinct programming interfaces may allow the first set of configuration data and the second set of configuration data to be programmed at different stages of the manufacturing process, where the non-volatile OTP memory may be programmed during wafer-level testing or final device testing while the non-volatile rewritable memory may be programmed during later assembly stages, configuration phases, or even post-manufacturing customization. The method may enable flexible manufacturing flows where immutable parameters are locked early through the non-volatile OTP memory while adjustable parameters remain programmable through the non-volatile rewritable memory until the EOM state is reached.

For example, the configuration inputs received by the apparatus 100 may be organized into three distinct groups that map to the two sets of configuration data generated by the method. A first group of configuration inputs may comprise the safety-critical parameters and the device identifier, which are defined by the semiconductor device manufacturer on a per-part basis for each individual physical instance of the target semiconductor device. A second group of configuration inputs may comprise the profile-specific operational parameters, which are defined by the semiconductor device manufacturer on a per-SKU (Stock Keeping Unit) basis to create different semiconductor device configuration profiles. A third group of configuration inputs may comprise the system-level operational parameters, which are defined by original equipment manufacturers (OEMs) on a per-SKU basis to customize the target semiconductor device for specific system implementations. The term SKU may designate distinct commercial product offerings that represent different performance tiers, feature sets, or market segments derived from the same underlying hardware platform.

For example, the first group of configuration inputs may be incorporated into the first set of configuration data for programming into the non-volatile OTP memory, establishing immutable foundational characteristics for each physical device. The second group and third group of configuration inputs may both be incorporated into the second set of configuration data for programming into the non-volatile rewritable memory, where the second group and third group are combined but governed by different security policies as reflected in the manifest and cryptographic signature. The organization into three input groups mapping to two output sets may provide flexibility by allowing manufacturer-controlled and OEM-controlled parameters to coexist in the rewritable storage while maintaining distinct security boundaries, enabling both product differentiation by the manufacturer and system customization by OEMs without requiring separate storage mechanisms for each parameter source.

For example, the second set of configuration data may be redundantly stored across a plurality of logical boot partitions on the non-volatile rewritable memory. The redundant storage may comprise storing multiple identical or substantially identical copies of the second set of configuration data in different locations or partitions within the non-volatile rewritable memory. The logical boot partitions may be distinct logical regions or segments of the non-volatile rewritable memory that are organized to support boot operations and system initialization. The redundant storage may provide fault tolerance and reliability by ensuring that the second set of configuration data remains accessible even if one copy becomes corrupted, damaged, or unreadable due to memory cell failures, write errors, or other storage media defects.

For example, the redundant storage across the plurality of logical boot partitions may enable the target semiconductor device to recover from data corruption events by reading an alternate copy of the second set of configuration data when a primary copy fails integrity checks. The target semiconductor device may implement repair logic or selection mechanisms that detect corrupted copies and automatically fall back to valid copies during boot sequences or configuration loading operations. The redundant storage approach may mirror the fault tolerance mechanisms traditionally used for hardware fuses, which often include redundant fuse banks with repair logic to handle fuse defects. The plurality of logical boot partitions may be two partitions providing dual redundancy, or may comprise more than two partitions for higher levels of redundancy. The redundant copies may be maintained in synchronization during configuration updates prior to the EOM state, and all copies may be locked simultaneously when immutability is enforced after the EOM state is reached.

For example, the second set of configuration data may be structured to include scatter-gather descriptors for use by a direct memory access (DMA) engine on the target semiconductor device. The scatter-gather descriptors may be data structures that specify memory operations to be performed by the DMA engine. The DMA engine may be a hardware component that can transfer data between memory locations or between memory and peripheral devices without requiring continuous involvement of a central processor. The scatter-gather descriptors may define a series of read and write operations where data is gathered from multiple source locations and scattered to multiple destination locations. Each scatter-gather descriptor may include information such as source addresses, destination addresses, data lengths, data masks, or other parameters that control how the DMA engine performs memory operations. The inclusion of scatter-gather descriptors in the second set of configuration data may enable the target semiconductor device to use the DMA engine to apply configuration values from the second set of configuration data to various memory locations efficiently.

For example, the structuring of the second set of configuration data to include scatter-gather descriptors may provide advantages in how configuration data is applied during device initialization or boot sequences. The DMA engine may use the scatter-gather descriptors to perform read-modify-write operations that update configuration values in disaggregated memory locations across the target semiconductor device. The scatter-gather approach may reduce fabric congestion by distributing memory write operations across multiple locations rather than performing large block transfers to contiguous memory regions. The scatter-gather descriptors may enable efficient patching or updating of configuration values that are stored in various distributed locations such as different IP blocks, functional units, or control registers throughout the target semiconductor device. The use of a DMA engine with scatter-gather descriptors may offload configuration application tasks from firmware processors, improving boot time performance and reducing processor overhead during initialization sequences.

### System-level Operational Parameters

Coming back to the configuration inputs. In some examples, the configuration inputs may further comprise system-level operational parameters. The system-level operational parameters may be configuration parameters provided by OEMs who integrate the target semiconductor device into larger systems or products. The system-level operational parameters may define settings and preferences that are specific to a particular system design, platform configuration, or end-user application. The system-level operational parameters may allow OEMs to customize the behavior and characteristics of the target semiconductor device for specific system requirements or customer needs without altering the fundamental device characteristics established by the semiconductor device manufacturer.

For example, the system-level operational parameters may differ from the profile-specific operational parameters in that the system-level operational parameters may be specified by entities downstream in the supply chain rather than by the semiconductor device manufacturer. The system-level operational parameters may include settings such as thermal management policies tailored to specific chassis designs, boot configuration preferences for particular system architectures, interface timing parameters optimized for specific peripheral combinations, or power management strategies adapted to particular battery configurations. The method may further comprise integrating the system-level operational parameters into the second set of configuration data alongside the profile-specific operational parameters. The system-level operational parameters may be included in the second set of configuration data that is programmed into the non-volatile rewritable memory. The integration may combine the system-level operational parameters from OEM sources with the profile-specific operational parameters from the semiconductor device manufacturer into a unified configuration data structure that will be programmed into the target semiconductor device.

For example, the system-level operational parameters may be subject to a second security policy distinct from a first security policy that applies to the profile-specific operational parameters. The first security policy may impose stricter requirements on the profile-specific operational parameters because the profile-specific operational parameters affect fundamental device characteristics, product segmentation, and market positioning. The second security policy may provide more flexibility for the system-level operational parameters to accommodate the needs of OEMs for system-level customization. The distinct security policies may implement different authentication mechanisms, where the first security policy may require signatures from semiconductor device manufacturer keys while the second security policy may accept signatures from authorized OEM keys. The distinct security policies may also impose different update permissions, where the profile-specific operational parameters may be locked at an earlier stage while the system-level operational parameters may remain updatable for a longer period.

For example, the configuration inputs may include system-level operational parameters from a laptop manufacturer specifying a fan speed curve optimized for a particular chassis thermal design, a boot logo preference for brand identification, and power management thresholds adapted to a specific battery capacity, where the system-level operational parameters are integrated into the second set of configuration data and authenticated using an OEM-specific cryptographic key under the second security policy. In some examples, the configuration inputs may include system-level operational parameters from a server manufacturer specifying PCI Express lane configurations for a specific server motherboard layout and memory timing parameters optimized for particular DRAM modules used in the server design, where the system-level operational parameters are integrated into the second set of configuration data for programming into the non-volatile rewritable memory.

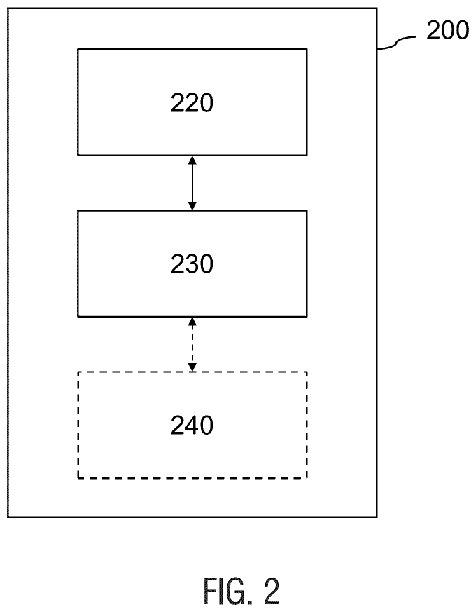

Further details and aspects are mentioned in connection with the examples described below. The example shown in FIG. 1 may include one or more optional additional features corresponding to one or more aspects mentioned in connection with the proposed concept or one or more examples described above below (e.g., FIGS. 2-12) .

FIG. 2 illustrates a block diagram of an example of an apparatus 200 or device 200. The apparatus 200 comprises circuitry that is configured to provide the functionality of the apparatus 200. For example, the apparatus 200 of FIG. 2 comprises interface circuitry 220, processing circuitry 230 and (optional) storage circuitry 240. For example, the processing circuitry 230 may be coupled with the interface circuitry 220 and optionally with the storage circuitry 240.

For example, the processing circuitry 230 may be configured to provide the functionality of the apparatus 200, in conjunction with the interface circuitry 220. For example, the interface circuitry 220 is configured to exchange information, e.g., with other components inside or outside the apparatus 200 and the storage circuitry 240. Likewise, the device 200 may comprise means that is/are configured to provide the functionality of the device 200.

The components of the device 200 are defined as component means, which may correspond to, or implemented by, the respective structural components of the apparatus 200. For example, the device 200 of FIG. 2 comprises means for processing 230, which may correspond to or be implemented by the processing circuitry 230, means for communicating 220, which may correspond to or be implemented by the interface circuitry 220, and (optional) means for storing information 240, which may correspond to or be implemented by the storage circuitry 240. In the following, the functionality of the device 200 is illustrated with respect to the apparatus 200. Features described in connection with the apparatus 200 may thus likewise be applied to the corresponding device 200.

In general, the functionality of the processing circuitry 230 or means for processing 230 may be implemented by the processing circuitry 230 or means for processing 230 executing machine-readable instructions. Accordingly, any feature ascribed to the processing circuitry 230 or means for processing 230 may be defined by one or more instructions of a plurality of machine-readable instructions. The apparatus 200 or device 200 may comprise the machine-readable instructions, e.g., within the storage circuitry 240 or means for storing information 240.

The interface circuitry 220 or means for communicating 220 may correspond to one or more inputs and/or outputs for receiving and/or transmitting information, which may be in digital (bit) values according to a specified code, within a module, between modules or between modules of different entities. For example, the interface circuitry 220 or means for communicating 220 may comprise circuitry configured to receive and/or transmit information.

For example, the processing circuitry 230 or means for processing 230 may be implemented using one or more processing units, one or more processing devices, any means for processing, such as a processor, a computer or a programmable hardware component being operable with accordingly adapted software. In other words, the described function of the processing circuitry 230 or means for processing 230 may as well be implemented in software, which is then executed on one or more programmable hardware components. Such hardware components may comprise a general-purpose processor, a Digital Signal Processor (DSP), a micro-controller, etc.

For example, the storage circuitry 240 or means for storing information 240 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

The processing circuitry 230 is configured receive configuration inputs for a target semiconductor device, the configuration inputs comprising a device identifier, one or more safety-critical parameters, and profile-specific operational parameters for one or more semiconductor device configuration profiles. The processing circuitry 230 is further configured generate a first set of configuration data for programming into a non-volatile one-time programmable, OTP, memory of the target semiconductor device. The first set of configuration data comprises the safety-critical parameters and the device identifier. The processing circuitry 230 is further configured generate a second set of configuration data for a non-volatile rewritable memory of the target semiconductor device, the second set of configuration data comprising the profile-specific operational parameters for a specific device configuration profile, a cryptographic signature and a manifest. The manifest is configured to bind the second set of configuration data to the device identifier and to enforce immutability of the second set of configuration data upon the target semiconductor device reaching a predefined lifecycle state.

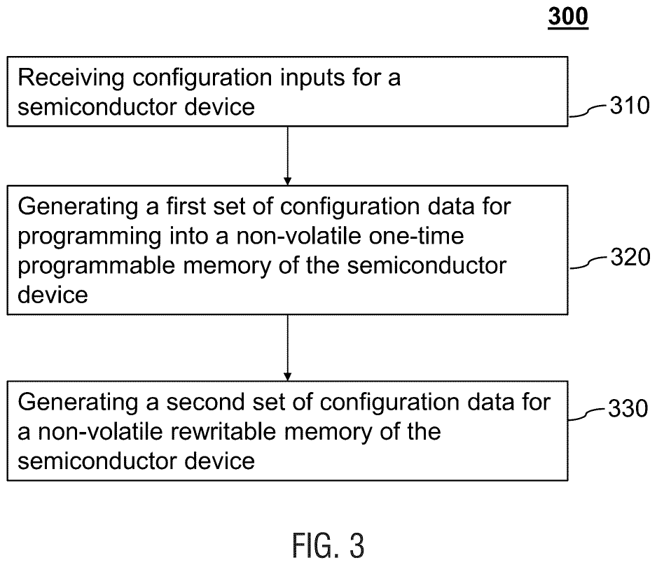

Further details and aspects are mentioned in connection with the examples described above or below. The example shown in FIG. 2 may include one or more optional additional features corresponding to one or more aspects mentioned in connection with the proposed concept or one or more examples described above (e.g., FIG. 1) or below (e.g., FIGS. 3-12) .

FIG. 3 illustrates a flowchart of an example of a method 300. The method 300 may, for instance, be performed by an apparatus as described herein, such as apparatus 100. The method 300 comprises receiving 310 configuration inputs for a target semiconductor device, the configuration inputs comprising a device identifier, one or more safety-critical parameters, and profile-specific operational parameters for one or more semiconductor device configuration profiles. The method 300 comprises further generating 320 a first set of configuration data for programming into a non-volatile one-time programmable, OTP, memory of the target semiconductor device, the first set of configuration data comprising the safety-critical parameters and the device identifier. The method 300 comprises further generating 330 a second set of configuration data for a non-volatile rewritable memory of the target semiconductor device, the second set of configuration data comprising the profile-specific operational parameters for a specific device configuration profile, a cryptographic signature and a manifest. The manifest is configured to bind the second set of configuration data to the device identifier and to enforce immutability of the second set of configuration data upon the target semiconductor device reaching a predefined lifecycle state.

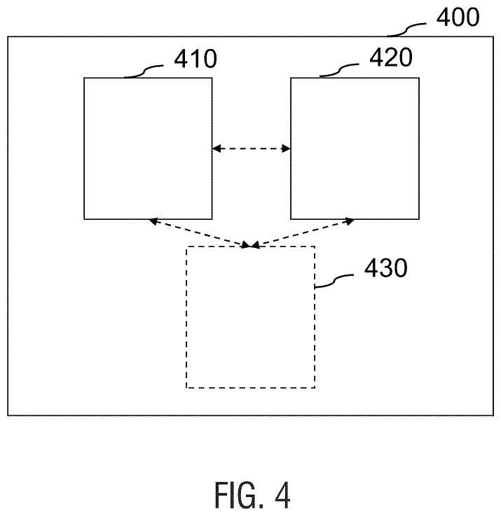

Further details and aspects are mentioned in connection with the examples described above or below. The example shown in FIG. 3 may include one or more optional additional features corresponding to one or more aspects mentioned in connection with the proposed concept or one or more examples described above (e.g., FIGS. 1-2) or below (e.g., FIGS. 4-12)

### Apparatus For Storing Configuration Data Of A Target Semiconductor Device

FIG. 4 illustrates an apparatus 400 for storing configuration data of a target semiconductor device. For example, the apparatus 400 described with reference to FIG. 4 may incorporate elements, components, and concepts (such as the non-volatile OTP memory and the a non-volatile rewritable memory) that have been described above with reference to FIGS. 1 to 3 and the method performed by the apparatus 100. The terminology, definitions, and technical details established in the preceding descriptions may apply equally to the apparatus unless explicitly stated otherwise. The apparatus may implement or embody the results of the method described above, where the configuration data generated by the apparatus 100 is programmed into the memories of the apparatus during manufacturing or configuration processes.

The apparatus 400 comprises a non-volatile OTP memory 410 storing a first set of configuration data for the target semiconductor device. The first set of configuration data comprises a device identifier and safety-critical parameters. The apparatus 400 further comprises a non-volatile rewritable memory 420 storing a second set of configuration data for the target semiconductor device. The second set of configuration data comprises profile-specific operational parameters, a cryptographic signature, and a manifest. The manifest is configured to bind the second set of configuration data to the device identifier and to enforce immutability of the second set of configuration data upon the apparatus reaching a predefined lifecycle state, such as End-of-Manufacturing (EOM) state.

For example, the combination of the non-volatile OTP memory 410 and the non-volatile rewritable memory 420 in the apparatus 400 may balance security and flexibility for device configuration. The signing on the device identifier may protect against unauthorized modification of safety-critical parameters. In some examples, the device identifier stored in the non-volatile OTP memory 410 may serve as a cryptographic anchor for binding the second set of configuration data. The cryptographic signature may provide authentication and integrity protection for the profile-specific operational parameters despite storage in rewritable memory 420. The manifest may implement binding mechanisms that prevent transplant attacks and lifecycle-aware immutability enforcement that locks configuration data after the EOM state. The apparatus 400 may enable product differentiation through different profile-specific operational parameters applied to identical hardware platforms while maintaining common safety boundaries defined in the first set of configuration data.

For example, the apparatus 400 may be implemented as part of the target semiconductor device or may comprise the target semiconductor device itself along with the associated memory components that store the configuration data. The target semiconductor device may be a dGPU, SoC, CPU, or accelerator as previously described, and the apparatus 400 may encompass the complete configuration storage architecture for the target semiconductor device. The non-volatile OTP memory 410 may be integrated directly onto the semiconductor die of the target semiconductor device during wafer fabrication processes, forming an integral part of the silicon chip structure. The non-volatile OTP memory 410 may occupy dedicated regions of the die layout where fuse arrays, antifuse structures, or other OTP memory cells are fabricated using specialized process steps. The integration of the non-volatile OTP memory 410 onto the die may ensure that the first set of configuration data cannot be physically separated from the target semiconductor device, providing strong security anchoring for the device identifier and safety-critical parameters.

For example, the non-volatile rewritable memory 420 may be implemented in various physical configurations depending on apparatus requirements and manufacturing approaches. The non-volatile rewritable memory 420 may be implemented as a separate flash memory chip mounted on the same package substrate as the target semiconductor device in a multi-chip package configuration, where the non-volatile rewritable memory 420 and the target semiconductor device are connected through bond wires, through-silicon vias, or package routing. The non-volatile rewritable memory 420 may alternatively be implemented as a discrete component on a printed circuit board alongside the target semiconductor device, where the non-volatile rewritable memory 420 communicates with the target semiconductor device through PCB traces and standard interface protocols such as SPI or 12C. The non-volatile rewritable memory 420 may be a NOR flash memory, NAND flash memory, or other rewritable non-volatile memory technology selected based on capacity requirements, access speed needs, and cost considerations. The physical separation or close integration of the non-volatile rewritable memory may depend on product design choices, where graphics cards may use discrete SPI flash chips while highly integrated SoCs may use package-integrated flash memory.

For example, the apparatus 400 may be manufactured through multi-stage processes that program the first set of configuration data and the second set of configuration data at different points in the manufacturing flow. The target semiconductor device with integrated non-volatile OTP memory 410 may be fabricated through front-end semiconductor processes including lithography, etching, deposition, and doping steps that create transistors and interconnects. The first set of configuration data may be programmed into the non-volatile OTP memory during wafer-level testing where individual dies are probed and tested for functionality, or during package-level testing after the die is assembled into a package with the non-volatile rewritable memory. The non-volatile rewritable memory 420 may be attached to the target semiconductor device through package assembly processes or through PCB assembly processes depending on the physical implementation. The second set of configuration data may be programmed into the non-volatile rewritable memory during final manufacturing stages, during board-level assembly, or even during post-manufacturing configuration phases where different semiconductor device configuration profiles are applied to create product variants. The apparatus 400 may be deployed in end products such as graphics cards installed in workstations, processors integrated into server motherboards, SoCs embedded in mobile devices, or accelerators deployed in data center infrastructure, where the apparatus provides configured semiconductor functionality according to the stored configuration data.

For example, the apparatus 400 may further comprise a direct memory access (DMA) engine 430. The DMA engine 430 may be a hardware component that can transfer data between memory locations without requiring continuous involvement of a central processor, as previously described. The DMA engine 430 may be configured to use scatter-gather descriptors included in the second set of configuration data to patch a working copy of configuration values in a volatile memory. The scatter-gather descriptors may specify memory operations where configuration values from the second set of configuration data are used to modify or update configuration values stored in the volatile memory. The working copy of configuration values may be a runtime version of configuration data that is actively used by functional components of the target semiconductor device during operation. The patching may involve read-modify-write operations where the DMA engine 430 reads existing values from the volatile memory, modifies the values based on the profile-specific operational parameters from the second set of configuration data, and writes the modified values back to the volatile memory.

For example, the DMA engine 430 may be integrated as a functional block within the target semiconductor device, implemented as dedicated hardware logic on the semiconductor die. The DMA engine 430 may be part of a apparatus controller, power management unit, or configuration management subsystem of the target semiconductor device. The volatile memory that holds the working copy of configuration values may be static random-access memory (SRAM), dynamic random-access memory (DRAM), or other volatile memory technologies integrated on the die or connected to the target semiconductor device. The volatile memory may provide fast access for functional components such as processing cores, execution units, or IP blocks that need to read configuration values during operation. The working copy in the volatile memory may initially be loaded with values from the first set of configuration data stored in the non-volatile OTP memory, and then the DMA engine 430 may patch the working copy using the profile-specific operational parameters from the second set of configuration data, creating a combined configuration state that reflects both the immutable safety-critical parameters and the profile-specific operational parameters for the active semiconductor device configuration profile.

For example, the second set of configuration data may be redundantly stored across a plurality of logical boot partitions on the non-volatile rewritable memory 420. The redundant storage may provide fault tolerance by maintaining multiple copies of the second set of configuration data in different logical regions of the non-volatile rewritable memory 420, as previously described. The logical boot partitions may be distinct segments of the non-volatile rewritable memory 420 organized to support boot operations and initialization sequences. The redundant storage may enable the apparatus to recover from data corruption by accessing an alternate copy when a primary copy fails integrity checks during boot or configuration loading operations. The plurality of logical boot partitions may be two partitions providing dual redundancy, or may comprise more than two partitions for higher levels of fault tolerance. The redundant copies may mirror traditional fuse redundancy mechanisms, ensuring that the second set of configuration data remains accessible even if memory cells fail or become corrupted in one or more partitions.

For example, the device identifier stored in the non-volatile OTP memory 410 may be a hardware-based unique identifier comprising at least one of a PCIe device identifier, a fused serial number, a MAC address, or an identifier derived from a PUF. The hardware-based unique identifier may provide strong security properties because the hardware-based unique identifier is difficult or impossible to clone or transfer between different physical devices, as previously described. A PCIe device identifier may identify the device type and manufacturer according to PCIe standards. A fused serial number may be a unique number permanently programmed by blowing fuses in the non-volatile OTP memory 410 during manufacturing. A MAC address may be a unique identifier assigned to network interfaces of the target semiconductor device. An identifier derived from a PUF may be generated based on intrinsic manufacturing variations unique to each device. The storage of the device identifier in the non-volatile OTP memory 410 may ensure that the device identifier cannot be modified after programming, providing a permanent cryptographic anchor for binding the second set of configuration data to the specific physical instance of the target semiconductor device through the manifest.

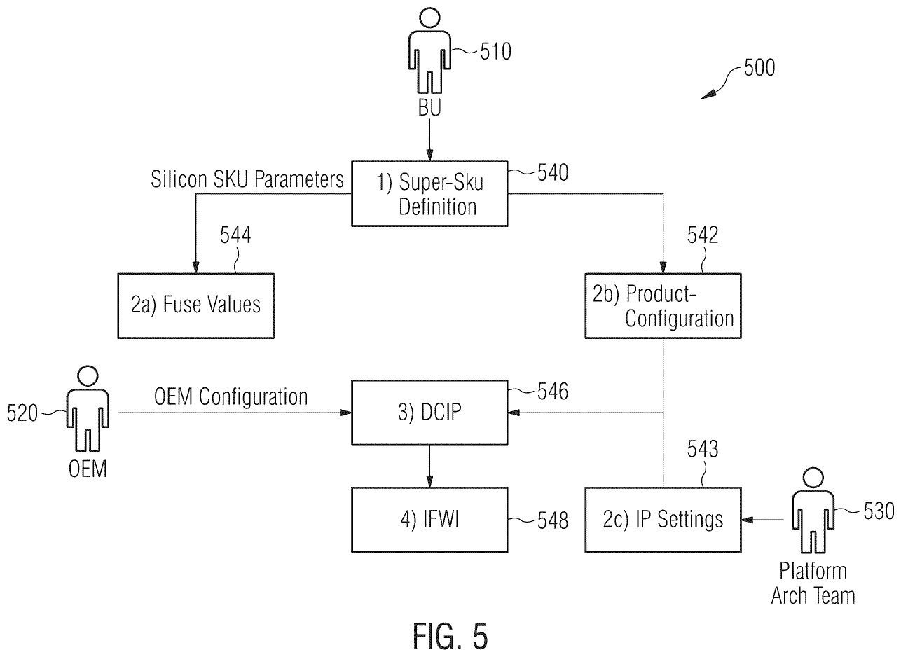

Further details and aspects are mentioned in connection with the examples described above or below. The example shown in FIG. 4 may include one or more optional additional features corresponding to one or more aspects mentioned in connection with the proposed concept or one or more examples described above (e.g., FIGS. 1-3) or below (e.g., FIGS. 5-12) .

FIG. 5 illustrates an example system 500 for generating configuration data for a semiconductor device. The system 500 represents a configuration generation workflow that combines immutable fuse-based configuration (first set of configuration data) with flexible soft SKU overrides (second set of configuration data, profile-specific operational parameters) that are authenticated based on a part's fused virtual SKU identifier (device identifier). The soft SKU overrides may be options encoded in SPI flash (non-volatile rewritable memory) which are authenticated based on the device identifier stored in fuses (non-volatile OTP memory). The overrides may integrate seamlessly with the same graphical user interface (GUI) for specifying configuration options for both semiconductor device manufacturers and OEMs, but may be treated at different security levels.

The system 500 shows interactions between multiple entities and data flows. A BU 510 (business unit, semiconductor device manufacturer) may provide inputs to the system. A Platform Arch Team 530 (platform architecture team) may provide IP Settings 543 (intellectual property configuration settings) to the system. An OEM 520 (original equipment manufacturer) may provide OEM Configuration inputs to the system. The system 500 comprises a Configuration Definition Stage 540 (configuration definition process) that receives Silicon SKU Parameters from the BU 510. The Configuration Definition Stage 540 may define configuration parameters in configuration definition cycles. The Configuration Definition Stage 540 may generate outputs that feed into subsequent stages of the configuration generation process. From the Configuration Definition Stage 540, the system 500 generates two parallel configuration paths. A first path 544 produces Fuse Values 544 (first set of configuration data for programming into non-volatile OTP memory, safety-critical parameters). The Fuse Values 544 may represent the immutable configuration parameters of the non-volatile OTP memory of the target semiconductor device. In some examples, the Fuse Values 544 may be can reprogrammable as long as In-Field Programmable fuse EOM might not set. A second path 542 produces Product Configuration 542 (profile-specific operational parameters, soft SKUs) which may be replicated from the same fuses defined in the Configuration Definition Stage 540 but can be overridden by the semiconductor device manufacturer architecture team.

The system 500 further comprises a dGPU Customization Portal (DICP) tool 546 (for example, configuration generation apparatus 100, processing circuitry 130 executing instructions from non-transitory computer-readable medium 140) that serves as a central configuration integration point. The DICP tool 546 may receive inputs from multiple sources including the Product Configuration 542 from the semiconductor device manufacturer, OEM Configuration from the OEM 520, and IP Settings 543 from the Platform Arch Team 530. The DICP tool 546 may provide the same frontend GUI but may exercise separate signing policies (first security policy and second security policy) for options at varying levels of security. The DICP tool 546 may be used by both semiconductor device manufacturer internal teams and OEMs to specify settings for specific products (semiconductor device configuration profiles).

The DICP tool 546 may enforce multiple security considerations for the second set of configuration data. The DICP tool 546 may enforce immutability, where the soft SKU data (second set of configuration data) should not be updatable beyond a certain lifecycle point such as End-of-Manufacturing (EOM, predefined lifecycle state). The act of setting EOM may be equivalent to the act of fuse burn-in as the enforcement point of immutability. On EOM locking, the soft SKU file may no longer be updatable via in-band firmware update tooling.

The DICP tool 546 may enforce integrity protection, where the soft SKU data may be integrity protected through cryptographic signatures such as XMSS signing of the soft SKU binary (cryptographic signature). The DICP tool 546 may enforce no-replaceability through binding, where the soft SKUing data may be anchored to a SKU (device identifier) in a manner that prevents a soft SKU file from one device from being copied and applied to another device. The no-replaceability may prevent stitching attacks (transplant attacks) that would allow premium features associated with a higher price SKU to be unlocked on a lower price SKU. The no-replaceability may be achieved by fusing the virtual SKU ID (device identifier) in the non-volatile OTP memory. The prevention of security exploits may also protect export-control restrictions where frequency, number of processing cores, or memory parameters may be constrained in the soft SKU file. The DICP tool 546 may enforce redundancy, where there may be multiple copies of the soft SKU binary in logical boot partitions (plurality of logical boot partitions on the non-volatile rewritable memory) similar to redundant fuse copies with repair logic. The virtual SKU ID may contain the PCle device identifier and may be included in the header of each soft SKU binary's manifest.

The DICP tool 546 may generate two outputs. A first output 548 may be Integrated Firmware Image (IFWI) 548 that contains the second set of configuration data for programming into the non-volatile rewritable memory. A second output 543 may be IP Settings 543 that may be provided to the Platform Arch Team 530. For previous generation devices with existing fuses, soft SKU overrides may still be achieved by overriding fuse banks using scatter-gather techniques (scatter-gather descriptors) to write to various disaggregated memory locations to prevent fabric congestion.

For example, in previous approaches product segmentation and differentiation for semiconductor devices may have been achieved through hardware fuses that are irreversibly blown at manufacturing time. These fuse settings may have allowed for various use cases such as workstation configurations, edge computing applications, and server deployments, as well as performance binning and per-part compensation based on manufacturing variations. For example, OEM configurability may have been provided through options programmable via SPI interfaces, colloquially referred to as BIOS options. However, these approaches may present limitations. The hardware fuse approach may suffer from drawbacks such as: Certain fuse settings require iterative tuning, but since fuses can only be blown once, this significantly increases manufacturing test time; each physical part can only be fused once, meaning that incorrect or unoptimized fused parts cannot be corrected, resulting in substantial material costs; and as hardware components, fuses may represent an expensive use of die space. For example, the BIOS options software approach may also have vulnerabilities: Even when data is authenticated and encrypted, the approach remains vulnerable to transplant exploits, also known as stitch attacks, where firmware can be extracted and transplanted to another physical part, potentially elevating the device to a higher price tier or causing device malfunction due to incompatible hardware configurations.

The system 500 may significantly reduce manufacturing test time by allowing quick iterations of testing and reduce material costs by reducing the number of configurations that can be set only once per physical part. The system 500 may provide further benefit in allowing for continual feature improvements in post-silicon by not tying configurations to hardware fuses.

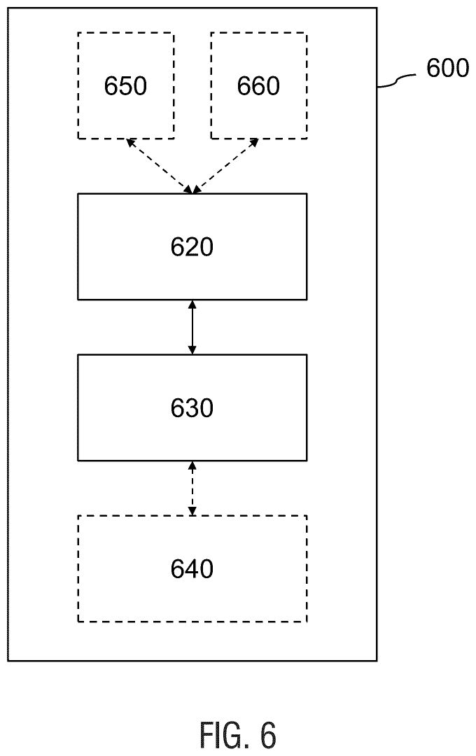

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-4) or below (e.g., FIGS. 6-12) .

### Cold Boot

FIG. 6 illustrates an apparatus 600 performing a cold sequence of a semiconductor device. For example, the apparatus 600 described with reference to FIG. 5 may incorporate elements, components, and concepts (such as the non-volatile OTP memory and the a non-volatile rewritable memory) that have been described above with reference to FIGS. 1 to 4. The terminology, definitions, and technical details established in the preceding descriptions may apply equally to the apparatus unless explicitly stated otherwise. The apparatus 600 may comprise or be connected to the apparatus 400 as described with regards to FIG. 4.

The apparatus 600 comprises circuitry that is configured to provide the functionality of the apparatus 600. For example, the apparatus 600 of FIG. 5 comprises interface circuitry 620, processing circuitry 630 and (optional) storage circuitry 640. For example, the processing circuitry 630 may be coupled with the interface circuitry 620 and optionally with the storage circuitry 640.

For example, the processing circuitry 630 may be configured to provide the functionality of the apparatus 600, in conjunction with the interface circuitry 620. For example, the interface circuitry 620 is configured to exchange information, e.g., with other components inside or outside the apparatus 600 and the storage circuitry 640. Likewise, the device 600 may comprise means that is/are configured to provide the functionality of the device 600.

The components of the device 600 are defined as component means, which may correspond to, or implemented by, the respective structural components of the apparatus 600. For example, the device 600 of FIG. 5 comprises means for processing 630, which may correspond to or be implemented by the processing circuitry 630, means for communicating 620, which may correspond to or be implemented by the interface circuitry 620, and (optional) means for storing information 640, which may correspond to or be implemented by the storage circuitry 640. In the following, the functionality of the device 600 is illustrated with respect to the apparatus 600. Features described in connection with the apparatus 600 may thus likewise be applied to the corresponding device 600.

In general, the functionality of the processing circuitry 630 or means for processing 630 may be implemented by the processing circuitry 630 or means for processing 630 executing machine-readable instructions. Accordingly, any feature ascribed to the processing circuitry 630 or means for processing 630 may be defined by one or more instructions of a plurality of machine-readable instructions. The apparatus 600 or device 600 may comprise the machine-readable instructions, e.g., within the storage circuitry 640 or means for storing information 640.

The interface circuitry 620 or means for communicating 620 may correspond to one or more inputs and/or outputs for receiving and/or transmitting information, which may be in digital (bit) values according to a specified code, within a module, between modules or between modules of different entities. For example, the interface circuitry 620 or means for communicating 620 may comprise circuitry configured to receive and/or transmit information.

For example, the processing circuitry 630 or means for processing 630 may be implemented using one or more processing units, one or more processing devices, any means for processing, such as a processor, a computer or a programmable hardware component being operable with accordingly adapted software. In other words, the described function of the processing circuitry 630 or means for processing 630 may as well be implemented in software, which is then executed on one or more programmable hardware components. Such hardware components may comprise a general-purpose processor, a Digital Signal Processor (DSP), a micro-controller, etc. In some examples, the processing circuitry 630 may comprise a scatter-gather direct memory access (SG-DMA) engine, or the processing circuitry 630 may be implemented as an SG-DMA engine. The SG-DMA engine may be a hardware component dedicated to performing memory transfer operations based on scatter-gather descriptors without requiring continuous processor intervention. The SG-DMA engine may be integrated as a functional block within the processing circuitry 630, or the SG-DMA engine may be a separate hardware component that works in conjunction with the processing circuitry 630 to perform the read-modify-write operations during the cold boot sequence.

For example, the storage circuitry 640 or means for storing information 640 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, the apparatus 600 may in some examples be integrated as part of the semiconductor device, implemented as a controller, management unit, or configuration subsystem within the semiconductor die of the semiconductor device. In some examples, the apparatus 600 may be implemented as a separate controller chip or management processor external to the semiconductor device and connected to the semiconductor device through package-level interconnects or board-level communication interfaces. The apparatus 600 may in some examples comprise the non-volatile OTP memory 650 and the non-volatile rewritable memory 660, for example when the apparatus 600 is integrated with the semiconductor device, or the apparatus 600 may be connected to the non-volatile OTP memory 650 and the non-volatile rewritable memory 660 that are part of or associated with the semiconductor device. The apparatus 600 may access the non-volatile OTP memory 650 and the non-volatile rewritable memory 660 through the interface circuitry 620.

For example, the connection between the apparatus 600 and the non-volatile OTP memory 650 may be implemented through dedicated on-die signal paths when the apparatus 600 and the non-volatile OTP memory 650 are both integrated on the same semiconductor die of the semiconductor device. The apparatus 600 may sense or read fuse values from the non-volatile OTP memory 650 through fuse sensing circuits that detect the programmed state of fuses or antifuses within the semiconductor device. The connection between the apparatus 600 and the non-volatile rewritable memory 660 may be implemented through the interface circuitry 620 using communication protocols such as SPI, I2C, or other serial interfaces, where the non-volatile rewritable memory 660 may be external to the semiconductor device or integrated within the same package as the semiconductor device. The interface circuitry 620 may provide the physical and logical communication layer that enables the apparatus 600 to read the second set of configuration data from the non-volatile rewritable memory 660. The apparatus 600 may be connected to a volatile memory of the semiconductor device through on-die memory buses, fabric interconnects, or other high-speed data paths that allow the apparatus 600 to access and modify the working copy of configuration values stored in the volatile memory during the cold boot sequence of the semiconductor device. The volatile memory may be SRAM, DRAM, or other volatile memory technologies integrated on the die of the semiconductor device or accessible to the semiconductor device.

The processing circuitry 630 may be configured, during a cold boot sequence of the semiconductor device to receive one or more machine-readable descriptors. For example, the cold boot sequence of the semiconductor device may be a startup or initialization process that occurs when the semiconductor device transitions from a powered-off state to a powered-on state. For example, the cold boot sequence may be distinguished from warm reset or hot reset sequences where the semiconductor device remains powered and certain circuit elements retain their state. During the cold boot sequence, volatile memory contents may be lost and hardware components may need to be reinitialized from non-volatile storage. The cold boot sequence may involve sensing configuration data from non-volatile memories, loading initial configuration values into volatile working memory, initializing functional blocks and IP components, and preparing the semiconductor device for normal operation. The cold boot sequence may be controlled or orchestrated by firmware, boot ROM code, or hardware state machines within the semiconductor device.

The one or more machine-readable descriptors may be data structures that contain instructions for memory operations to be performed by the processing circuitry 630. The one or more machine-readable descriptors may specify how configuration values from the second set of configuration data should be applied to modify a working copy of configuration values in the volatile memory.

The one or more machine-readable descriptors are generated based on a second set of configuration data of the semiconductor device stored in the non-volatile rewritable memory 660 of the semiconductor device. The generation of the one or more machine-readable descriptors may be performed by firmware executing on a controller of the semiconductor device, such as a power management unit or trusted firmware agent, that reads the second set of configuration data from the non-volatile rewritable memory 660 and translates the profile-specific operational parameters into descriptor formats suitable for processing by the processing circuitry 630.

For example, the one or more machine-readable descriptors may comprise at least one of a physical address in the volatile memory, a data mask, or a data length. The physical address in the volatile memory may specify a target location within the volatile memory where a read-modify-write operation should be performed. The physical address may identify a specific register, memory cell, or memory region that holds configuration values to be modified. The data mask may specify which bits or fields within a memory location should be modified during the read-modify-write operation. The data mask may allow selective updating of certain bits while preserving other bits in the same memory location. The data length may specify the size or extent of data to be read, modified, or written during the memory operation. The data length may indicate how many bytes, words, or other data units are involved in the operation.

For example, the one or more machine-readable descriptors may include multiple fields that together define a complete memory operation for the processing circuitry 630 to execute. A single machine-readable descriptor may include a physical address field pointing to a specific location in the volatile memory where a configuration value resides, a data mask field indicating which bits of that configuration value should be updated, and a data length field specifying how many bytes to process. The processing circuitry 630 may use the physical address to locate the target memory location, apply the data mask to selectively modify specific bits based on patch data from the second set of configuration data, and use the data length to determine the extent of the read-modify-write operation. For example, a machine-readable descriptor may specify a physical address of 0×1000 in the volatile memory, a data mask of 0×FF00 to modify only the upper byte of a 16-bit value, and a data length of 2 bytes.

For example, the processing circuity 630 may receive the one or more machine-readable descriptors from a trusted firmware agent executing on a controller of the semiconductor device. The trusted firmware agent may be firmware code that runs in a secure execution environment with elevated privileges and access rights within the semiconductor device. The trusted firmware agent may be responsible for reading the second set of configuration data from the non-volatile rewritable memory 660, validating the cryptographic signature and manifest, and generating the one or more machine-readable descriptors based on the profile-specific operational parameters. The controller of the semiconductor device may be a power management unit (Punit), a system controller, a security processor, or similar control logic that manages initialization and configuration operations during boot sequences. The trusted firmware agent executing on the controller may act as a manager or orchestrator that prepares configuration instructions for the apparatus 600 to execute.

For example, the trusted firmware agent may read the second set of configuration data from the non-volatile rewritable memory 660, verify the binding to the device identifier and check the manifest for lifecycle state information, and then parse the profile-specific operational parameters to create the one or more machine-readable descriptors. The trusted firmware agent may translate the profile-specific operational parameters into the descriptor format expected by the processing circuitry 630, including the physical addresses, data masks, data lengths, and patch data values. The processing circuitry 630 may receive the one or more machine-readable descriptors through the interface circuitry 620 from the trusted firmware agent or controller that generated the one or more machine-readable descriptors. The one or more machine-readable descriptors may be transmitted to the processing circuitry 630 through on-chip communication fabrics, register interfaces, or dedicated descriptor queues. The processing circuitry 630 may read the one or more machine-readable descriptors from shared memory locations where the trusted firmware agent has written the one or more machine-readable descriptors. For example, the one or more machine-readable descriptors may be formatted according to protocols understood by the SG-DMA engine. The one or more machine-readable descriptors may be scatter-gather descriptors that include fields specifying memory addresses, data values, data masks, and operation types for patching the working copy of configuration values in the volatile memory.

For example, the second set of configuration data may comprise at least one parameter selected from a group consisting of a product-specific operational frequency, a power budget, a number of enabled processing cores, a feature enablement flag, and an export-control parameter. The second set of configuration data may contain the profile-specific operational parameters that define operational characteristics for different semiconductor device configuration profiles or product variants, as previously described. A product-specific operational frequency may specify an operating clock frequency for a particular product tier or market segment. A power budget may specify an allocated power consumption limit for the semiconductor device in a specific configuration. A number of enabled processing cores may define how many computational elements are active in a particular product variant. A feature enablement flag may indicate whether specific functional capabilities are activated or deactivated. An export-control parameter may specify operational restrictions imposed for compliance with export regulations in certain geographic regions. The second set of configuration data may be stored in the non-volatile rewritable memory 660 and may be used by the trusted firmware agent to generate the one or more machine-readable descriptors that the apparatus 600 uses to patch the working copy of configuration values during the cold boot sequence.

For example, the second set of configuration data may comprise at least one parameter selected from a group consisting of a product-specific operational frequency, a power budget, a number of enabled processing cores, a feature enablement flag, and an export-control parameter. The second set of configuration data may be the configuration data stored in the non-volatile rewritable memory 660 that contains the profile-specific operational parameters for defining different semiconductor device configuration profiles or product variants. The second set of configuration data may enable product differentiation by specifying different operational characteristics for the same underlying hardware platform of the semiconductor device. A product-specific operational frequency may define the clock speed for a particular product tier. A power budget may specify power consumption limits for the semiconductor device. A number of enabled processing cores may determine how many CPU cores, GPU cores, or execution units within the semiconductor device are active. A feature enablement flag may control whether specific capabilities of the semiconductor device are activated. An export-control parameter may impose operational restrictions for regulatory compliance in certain geographic regions. The trusted firmware agent may read these parameters from the second set of configuration data during the cold boot sequence and generate the one or more machine-readable descriptors that instruct the apparatus 600 to patch the working copy of configuration values in the volatile memory with these profile-specific operational parameters.

The processing circuitry 630 may be further configured, during the cold boot sequence of the semiconductor device to perform a read-modify-write operation on a working copy of configuration values stored in a volatile memory of the semiconductor device based on patch data included in the one or more descriptors. For example, the read-modify-write operation may be a memory operation sequence that reads an existing value from a memory location, modifies part or all of the value according to specified parameters, and writes the modified value back to the same or a different memory location. The read-modify-write operation may allow selective updating of specific bits or fields within a configuration value while preserving other bits that should remain unchanged. For example, the volatile memory of the semiconductor device may be integrated directly on the semiconductor die of the semiconductor device, implemented as on-chip memory arrays or register banks. The volatile memory may be the storage circuitry 640 of the apparatus 600, or the volatile memory may be separate storage accessible to the apparatus 600. The volatile memory may serve as working memory that holds the working copy of configuration values during operation of the semiconductor device. The volatile memory may be accessed by various IP blocks, processing cores, execution units, and other functional components of the semiconductor device to read configuration parameters that control their operation.

The patch data may be configuration values derived from the profile-specific operational parameters in the second set of configuration data. For example, the patch data included in the one or more machine-readable descriptors may comprise profile-specific operational parameters derived from the second set of configuration data. The patch data may be the actual configuration values that are applied during the read-modify-write operations to modify the working copy of configuration values in the volatile memory. The profile-specific operational parameters may be extracted or derived from the second set of configuration data by the trusted firmware agent during the cold boot sequence. The trusted firmware agent may read the profile-specific operational parameters from the non-volatile rewritable memory 660, validate the cryptographic signature and manifest, and then incorporate the profile-specific operational parameters into the one or more machine-readable descriptors as patch data. The patch data may include values such as the product-specific operational frequency, the power budget, the number of enabled processing cores, feature enablement flags, or export-control parameters that were defined in the second set of configuration data for the specific semiconductor device configuration profile.

For example, the patch data may represent the operational characteristics that differentiate one product variant from another product variant of the semiconductor device. The patch data derived from the profile-specific operational parameters may be applied to the working copy that was initially loaded with values from the first set of configuration data, creating a combined configuration state that includes both the immutable safety-critical parameters from the non-volatile OTP memory 650 and the flexible profile-specific operational parameters from the non-volatile rewritable memory 660. For example, if the second set of configuration data specifies a product-specific operational frequency of 2.0 GHz for a mid-tier dGPU variant, the trusted firmware agent may extract this value and include it as patch data in a machine-readable descriptor, which the processing circuitry 630 then uses to update the frequency configuration field in the working copy stored in the volatile memory.

The processing circuitry 630 may read a current configuration value from a location in the volatile memory specified by a physical address in a machine-readable descriptor. The processing circuitry 630 may apply a data mask from the machine-readable descriptor to identify which bits should be modified. The processing circuitry 630 may combine the patch data with the masked portion of the read value to create a modified configuration value. The processing circuitry 630 may write the modified configuration value back to the volatile memory. The read-modify-write operation may enable the apparatus 600 to update the working copy with profile-specific operational parameters from the second set of configuration data while preserving safety-critical parameters or other fields that were initially loaded from the first set of configuration data.

For example, the read-modify-write operation may be configured to write the modified one or more configuration values to a plurality of disaggregated memory locations within the volatile memory to reduce fabric congestion. Disaggregated memory locations may be memory addresses that are distributed across different regions, banks, or physical areas of the volatile memory rather than being concentrated in a single contiguous block. The writing to disaggregated memory locations may distribute memory traffic across multiple communication paths or fabric interconnects within the semiconductor device. The distribution may reduce congestion on any single communication channel or bus by spreading the write operations across multiple parallel paths. The reduction in fabric congestion may improve overall system performance during the cold boot sequence by avoiding bottlenecks that would occur if all configuration writes targeted a single memory region.

For example, the SG-DMA engine may be configured to perform the read-modify-write operation. The SG-DMA engine within or associated with the processing circuitry 630 may execute the memory operations specified in the one or more machine-readable descriptors. The SG-DMA engine may read configuration values from the volatile memory at physical addresses specified in the scatter-gather descriptors. The SG-DMA engine may apply data masks from the scatter-gather descriptors to identify which bits should be modified. The SG-DMA engine may combine the patch data with the masked portions to create modified configuration values. The SG-DMA engine may write the modified configuration values back to the volatile memory at the specified physical addresses or to disaggregated memory locations. The SG-DMA engine may perform these operations without requiring continuous intervention from a central processor, operating autonomously based on the scatter-gather descriptors provided by the trusted firmware agent. The SG-DMA engine may process multiple descriptors sequentially or in parallel, executing a series of read-modify-write operations to patch the working copy of configuration values across multiple locations in the volatile memory during the cold boot sequence.

For example, the one or more machine-readable descriptors may specify physical addresses that are scattered across different memory banks or regions of the volatile memory, and the processing circuitry 630 may execute the read-modify-write operations sequentially or in parallel to update configuration values at these distributed locations. For example, rather than writing all modified configuration values to a single centralized fuse SRAM bank, the processing circuitry 630 may write frequency configuration values to one memory region, power management values to another memory region, and feature enablement flags to yet another memory region, distributing the memory traffic across multiple fabric paths.

The working copy is initially loaded with values from a first set of configuration data of the semiconductor device stored in a non-volatile OTP memory 650 of the semiconductor device. The working copy may start as a direct copy or representation of the first set of configuration data that is read from the non-volatile OTP memory 650 during early stages of the cold boot sequence. A chassis fuse controller or similar sensing circuitry may read the fuse values from the non-volatile OTP memory 650 and distribute these values to the volatile memory to create the initial working copy. The initial loading may establish baseline configuration values that include the safety-critical parameters and the device identifier. The working copy in the volatile memory may then serve as the foundation upon which the profile-specific operational parameters from the second set of configuration data are applied through the read-modify-write operations. The initial loading from the first set of configuration data may ensure that fundamental device limits and identification are established before any flexible profile-specific parameters are applied.

For example, the first set of configuration data may comprise at least one parameter selected from a group consisting of a device identifier, a maximum hardware operational frequency, a maximum operational voltage, and a maximum thermal threshold. The first set of configuration data may contain the immutable parameters that define fundamental operational limits and unique identification of the semiconductor device, as previously described. The device identifier may uniquely identify the specific physical instance of the semiconductor device. The maximum hardware operational frequency may establish the highest clock frequency at which the semiconductor device can safely operate. The maximum operational voltage may define the highest supply voltage that can be applied without causing damage. The maximum thermal threshold may specify the highest temperature the semiconductor device can reach before thermal protection mechanisms should engage. These parameters from the first set of configuration data may be permanently stored in the non-volatile OTP memory 650 and may form the initial content of the working copy before the read-modify-write operations apply the profile-specific operational parameters.

For example, during the cold boot sequence, the chassis fuse controller may sense a maximum hardware operational frequency of 2.5 GHz and a device identifier from the non-volatile OTP memory 650 and write these values to the volatile memory to create the initial working copy. The processing circuitry 630 may then perform read-modify-write operations using patch data that includes a product-specific operational frequency of 2.0 GHz derived from the second set of configuration data, modifying the working copy to include both the immutable maximum limit of 2.5 GHZ and the profile-specific operating frequency of 2.0 GHz.

The processing circuitry 630 may be further configured, during the cold boot sequence of the semiconductor device to generate a completion signal for causing a readiness signal to be asserted to enable one or more functional components of the semiconductor device to access the modified working copy. The completion signal may be a signal or indicator generated by the processing circuitry 630 to notify other components that the read-modify-write operations have been completed. The completion signal may be an interrupt request (IRQ), a status bit, a hardware signal, or a message sent through on-chip communication fabrics. The generation of the completion signal may occur after the processing circuitry 630 has finished processing all of the one or more machine-readable descriptors and has completed all patching operations on the working copy in the volatile memory.

For example, the readiness signal may be a control signal that indicates to the functional components of the semiconductor device that the working copy of configuration values is ready for access. The readiness signal may act as a synchronization mechanism that prevents the functional components from reading configuration values before the working copy has been fully initialized and patched. For example, the readiness signal may comprise a gating bit that acts as a barrier for the one or more functional components. The gating bit may be a single bit flag, register bit, or hardware signal line that controls access to the working copy of configuration values. The gating bit may implement a binary access control mechanism where a first state (such as 0 or logic low) prevents access and a second state (such as 1 or logic high) permits access. The gating bit may act as a barrier by blocking the one or more functional components from reading or accessing the working copy in the volatile memory until the gating bit is set to the permissive state. The barrier function may be implemented through hardware logic that gates data paths, clock enables, or read enable signals for the configuration registers or memory locations holding the working copy.

For example, the gating bit may be cleared or set to the blocking state at the beginning of the cold boot sequence before the working copy is loaded and patched. The functional components may check the gating bit before attempting to access configuration values, and may enter a wait state or stall their initialization if the gating bit indicates that the working copy is not ready. When the processing circuitry 630 generates the completion signal after finishing all read-modify-write operations, the completion signal may cause the gating bit to be set to the permissive state, asserting the readiness signal. The functional components monitoring the gating bit may then proceed to read their required configuration values from the modified working copy. The gating bit may be implemented as a FuseReady bit, a ConfigReady flag, or similar indicator that serves as the synchronization point between the configuration loading process and the functional component initialization process. For example, the gating bit may be implemented in a control register accessible to the functional components, where graphics processing units, security modules, and memory controllers poll or monitor the gating bit before accessing their respective configuration parameters from the working copy in the volatile memory.

The readiness signal may be asserted in response to receiving the completion signal from the processing circuitry 630. The assertion of the readiness signal may change a gating bit, enable signal, or barrier flag from an inactive state to an active state. The one or more functional components of the semiconductor device may be IP blocks, processing cores, execution units, graphics engines, memory controllers, security modules, or other hardware elements that require configuration parameters to operate correctly. These functional components may monitor the readiness signal and may wait until the readiness signal is asserted before attempting to read configuration values from the working copy in the volatile memory.

The described technique may prevent race conditions where functional components might read incomplete or inconsistent configuration data during the patching process. The mechanism may ensure that functional components receive a consistent view of configuration data that includes both the safety-critical parameters from the first set of configuration data and the profile-specific operational parameters from the second set of configuration data.

For example, the apparatus 600 may enable efficient and flexible configuration of the semiconductor device during cold boot sequences while maintaining strong security boundaries between immutable and mutable configuration parameters. The apparatus 600 may allow the semiconductor device to combine safety-critical parameters permanently stored in the non-volatile OTP memory with profile-specific operational parameters stored in the non-volatile rewritable memory, creating a hybrid configuration approach that balances security and flexibility. The apparatus 600 may provide synchronization mechanisms through the completion signal and readiness signal that prevent functional components from accessing incomplete or inconsistent configuration data during the patching process. The apparatus 600 may enable product differentiation by applying different profile-specific operational parameters to physically identical semiconductor devices through the read-modify-write operations on the working copy. The apparatus 600 may reduce fabric congestion by distributing configuration writes across disaggregated memory locations within the volatile memory. The apparatus 600 may allow post-manufacturing flexibility in setting operational parameters without requiring hardware fuse changes, reducing material costs and manufacturing test time. The apparatus 600 may provide backwards compatibility by maintaining the working copy in volatile memory that can be accessed by functional components in the same manner as traditional fuse-based configurations.

For example, after the processing circuitry 630 completes the read-modify-write operations and writes the modified configuration values back to the volatile memory, the modified configuration values may be updated or latched into receiver registers. The receiver registers may be configuration registers or register banks within the semiconductor device that hold configuration values for access by the one or more functional components. The updating or latching into receiver registers may transfer the modified configuration values from the volatile memory into dedicated register locations associated with early boot IP blocks or functional components. The exposure of the updated fields may make the modified configuration values visible to the one or more functional components by enabling read access to the receiver registers. The completion signal generated by the processing circuitry 630 may trigger the updating and exposure of the receiver registers before the readiness signal is asserted. The receiver registers may serve as an interface layer between the volatile memory holding the working copy and the functional components that consume the configuration values.

For example, after the readiness signal is asserted, the one or more functional components may perform parallel pull operations to read their required configuration values from the receiver registers or from the modified working copy in the volatile memory. The one or more functional components may include graphics processing units (GT), security modules, memory physical layer controllers (DDR PHY), and other IP blocks within the semiconductor device. Each functional component may pull specific configuration fields relevant to that functional component's operation, where a graphics processing unit may read frequency and power budget parameters, a security module may read security-related configuration parameters and feature enablement flags, and a memory physical layer controller may read memory timing and calibration parameters. The functional components may latch and decode the pulled configuration values into internal registers or state machines within each functional component. The latching may capture the configuration values into local storage within the functional component, and the decoding may interpret the configuration values to configure operational parameters. The parallel pulling may occur simultaneously or in an overlapping manner across multiple functional components once the gating bit indicates that the modified working copy is ready, with each functional component independently accessing the configuration values it requires without waiting for other functional components to complete their pulls.

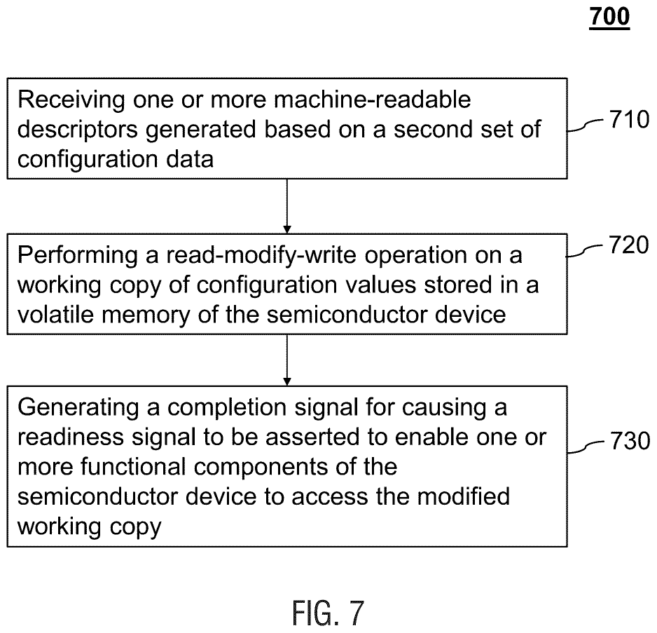

Further details and aspects are mentioned in connection with the examples described above or below. The example shown in FIG. 6 may include one or more optional additional features corresponding to one or more aspects mentioned in connection with the proposed concept or one or more examples described above (e.g., FIGS. 1-5) or below (e.g., FIGS. 7-12) .

FIG. 7 illustrates a flowchart of an example of a method for performing a cold boot sequence on a semiconductor device 700. The method 700 may, for instance, be performed by an apparatus as described herein, such as apparatus 600. The method 700 comprises during a cold boot sequence of the semiconductor device receiving 710 one or more machine-readable descriptors, which are generated based on a second set of configuration data of the semiconductor device stored in a non-volatile rewritable memory of the semiconductor device. The method 700 further comprises during a cold boot sequence of the semiconductor device performing 720 a read-modify-write operation on a working copy of configuration values stored in a volatile memory of the semiconductor device based on patch data included in the one or more descriptors. The working copy is initially loaded with values from a first set of configuration data of the semiconductor device stored in a non-volatile one-time programmable, OTP, memory of the semiconductor device. The method 700 further comprises during a cold boot sequence of the semiconductor device generating 730 a completion signal for causing a readiness signal to be asserted to enable one or more functional components of the semiconductor device to access the modified working copy.

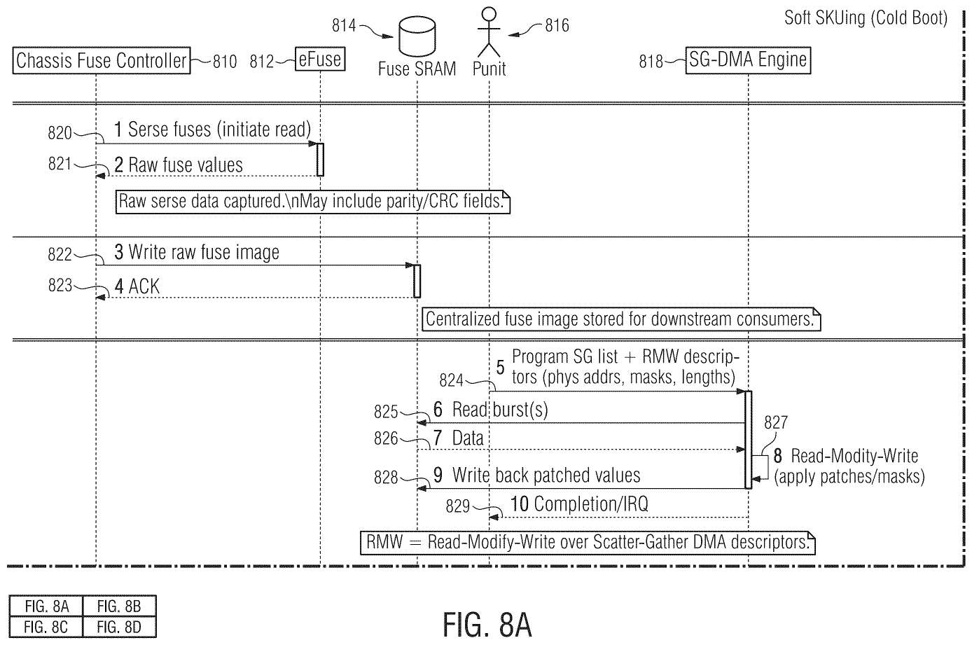

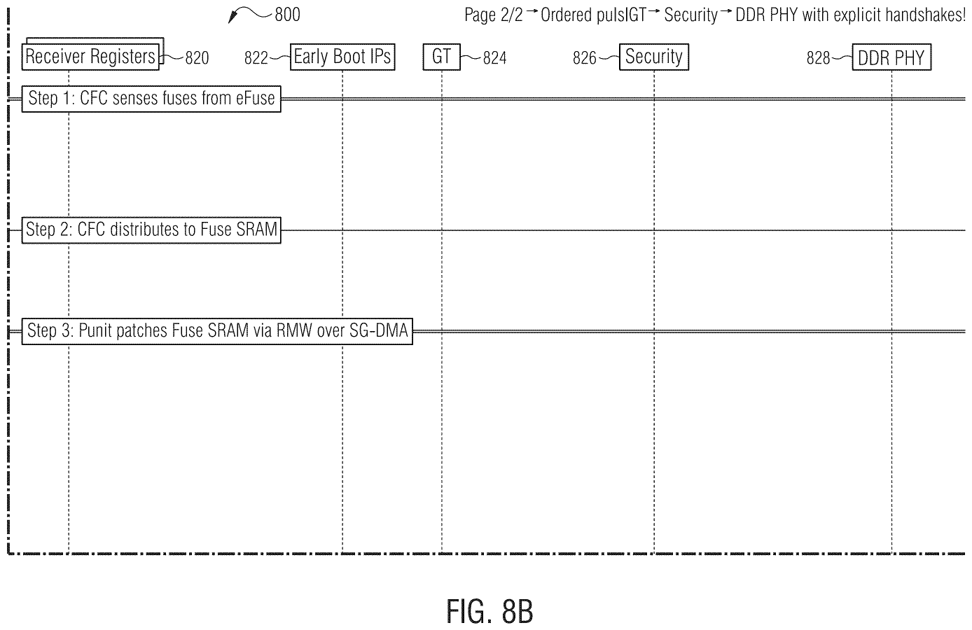

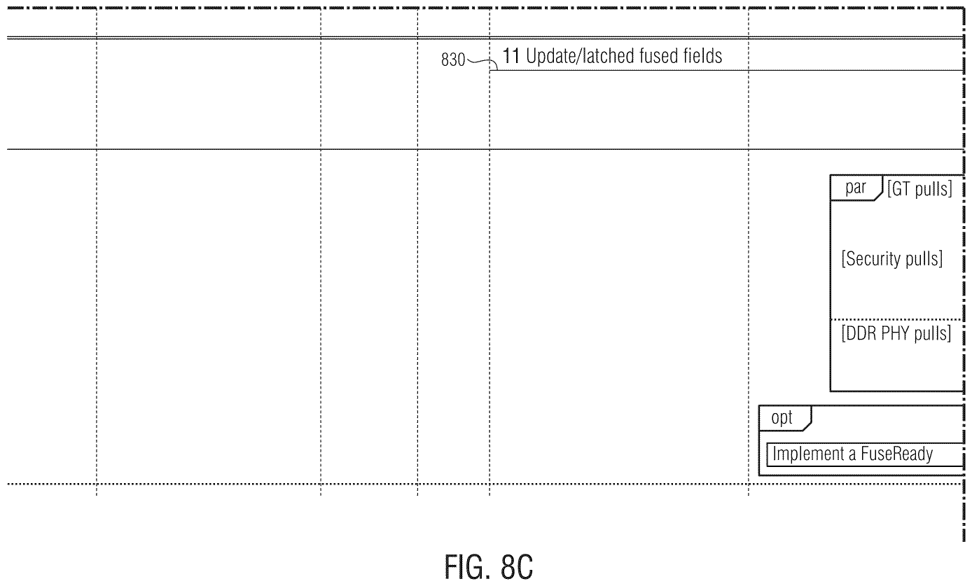

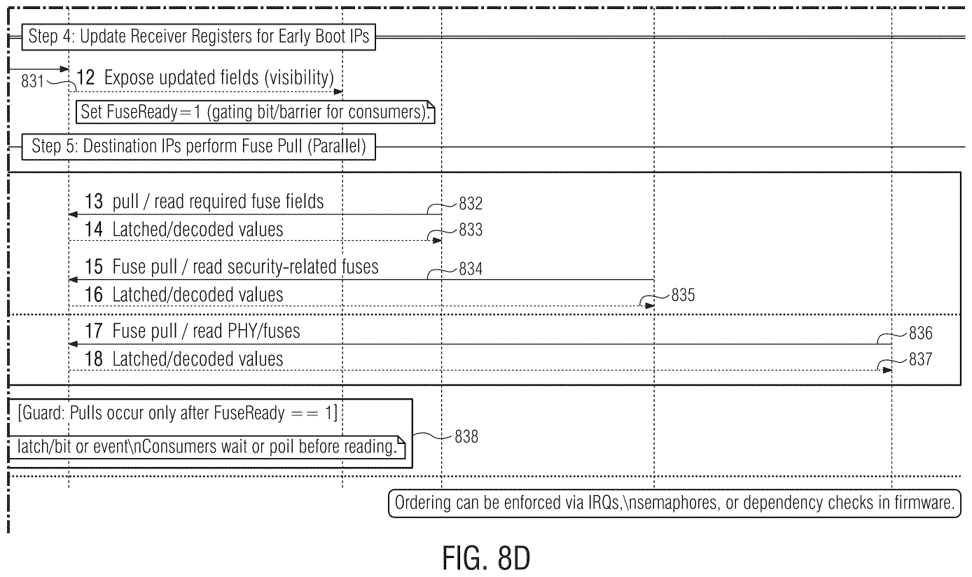

Further details and aspects are mentioned in connection with the examples described above or below. The example shown in FIG. 7 may include one or more optional additional features corresponding to one or more aspects mentioned in connection with the proposed concept or one or more examples described above (e.g., FIGS. 1-6) or below (e.g., FIGS. 8A-12) .

FIGS. 8A-8D, which form a single figure, illustrate an example flow 800 for a cold boot sequence of the semiconductor device. The flow 800 represents a configuration initialization process that combines immutable configuration data from non-volatile OTP memory with flexible profile-specific operational parameters from non-volatile rewritable memory to create a working copy of configuration values. The flow 800 should mimic hardware fuse behavior, and therefore applies on cold reset exit when the semiconductor device transitions from a powered-off state to a powered-on state.

The flow 800 shows interactions between a Chassis Fuse Controller 810, eFuse 812 (for example the non-volatile OTP memory 550), Fuse SRAM 816 (for example the volatile memory, storage circuitry 540), Punit 814 (for example a power management unit, trusted firmware agent), SG-DMA Engine 818 (for example processing circuitry 530 or a component thereof), Receiver Registers 820 (latched registers), Early Boot IPs 824 (early boot IP blocks), and functional components including GT 826 (graphics processing unit), Security 828 (security module), and DDR PHY 830 (memory physical layer controller).

The flow 800 begins with Step 1, CFC senses fuses from eFuse. At step 820, the Chassis Fuse Controller 810 senses fuses by initiating read operations. At step 821, raw fuse values are obtained from the eFuse 812. The raw sense data captured may include parity and CRC (cyclic redundancy check) fields for integrity verification.

The flow 800 continues with Step 2, CFC distributes to Fuse SRAM. At step 822, the Chassis Fuse Controller 810 writes the raw fuse image to the Fuse SRAM 816. At step 823, an acknowledgment (ACK) is received confirming the write operation. The centralized fuse image is stored in the Fuse SRAM 816 for downstream consumers, creating the initial working copy of configuration values loaded with values from the first set of configuration data.

The flow 800 proceeds with Step 3, Punit patches Fuse SRAM via RMW over SG-DMA. At step 824, the Punit 814 programs an SG list with RMW (read-modify-write) descriptors containing physical addresses, masks, and lengths. These machine-readable descriptors are generated based on the second set of configuration data stored in the non-volatile rewritable memory. At step 825, the SG-DMA Engine 818 reads burst(s) from the Fuse SRAM 816. At step 826, data is retrieved from the Fuse SRAM 816. At step 827, the SG-DMA Engine 818 performs read-modify-write operations by applying patches and masks to the working copy. At step 828, the SG-DMA Engine 818 writes back patched values to the Fuse SRAM 816, modifying the working copy with profile-specific operational parameters derived from the second set of configuration data. At step 829, a completion signal (Completion/IRQ) is generated. The RMW operations represent read-modify-write over scatter-gather DMA descriptors.

The flow 800 continues with Step 4, Update Receiver Registers for Early Boot IPs. At step 830, the modified configuration values are updated or latched into fused fields of the Receiver Registers 820. At step 831, the updated fields are exposed to provide visibility to the functional components. The readiness signal FuseReady=1 is set, serving as a gating bit or barrier for consumers (functional components), thereby asserting the readiness signal to enable the functional components to access the modified working copy.

The flow 800 concludes with Step 5, Destination IPs perform Fuse Pull (Parallel). The functional components (GT 826, Security 828, DDR PHY 830) perform parallel pull operations to read their required configuration values from the Receiver Registers 820. At step 832, the GT pulls or reads required fuse fields (configuration values). At step 833, the GT latches and decodes the pulled values into internal registers. At step 834, the Security module pulls or reads security-related fuses (configuration parameters). At step 835, the Security module latches and decodes the pulled values. At step 836, the DDR PHY pulls or reads PHY calibration fuses (memory timing and calibration parameters). At step 837, the DDR PHY latches and decodes the pulled values. At step 838, a guard condition ensures that pulls occur only after FuseReady equals 1, meaning consumers poll or wait for the readiness signal (FuseReady, gating bit) before reading configuration values. The implementation may use a FuseReady latch/bit or event where consumers wait or poll before reading.

The flow 800 enables flexible product differentiation by allowing different profile-specific operational parameters to be applied to the same underlying hardware platform through the patching process, while maintaining immutable safety-critical parameters in the non-volatile OTP memory. The ordering of operations can be enforced via IRQs, semaphores, or dependency checks in firmware.

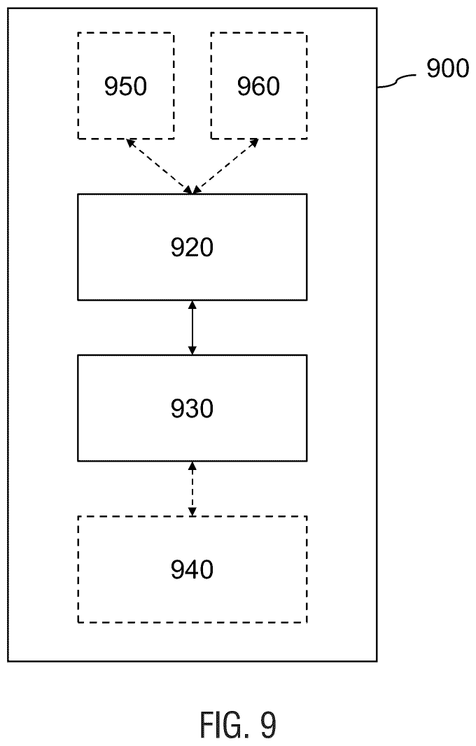

Further details and aspects are mentioned in connection with the examples described above or below. The example shown in FIGS. 8A-8D may include one or more optional additional features corresponding to one or more aspects mentioned in connection with the proposed concept or one or more examples described above (e.g., FIGS. 1-7) or below (e.g., FIG. 9 12).

### Warm Rest

FIG. 9 illustrates an apparatus 900 performing a warm reset exit of a semiconductor device. For example, the apparatus 900 described with reference to FIG. 9 may incorporate elements, components, and concepts (such as the non-volatile OTP memory and the a non-volatile rewritable memory) that have been described above with reference to FIGS. 1 to 8. The terminology, definitions, and technical details established in the preceding descriptions may apply equally to the apparatus unless explicitly stated otherwise. The apparatus 900 may comprise or be connected to the apparatus 400 as described with regards to FIG. 4.

The apparatus 900 comprises circuitry that is configured to provide the functionality of the apparatus 900. For example, the apparatus 900 of FIG. 9 comprises interface circuitry 920, processing circuitry 930 and (optional) storage circuitry 940. For example, the processing circuitry 930 may be coupled with the interface circuitry 920 and optionally with the storage circuitry 940.

For example, the processing circuitry 930 may be configured to provide the functionality of the apparatus 900, in conjunction with the interface circuitry 920. For example, the interface circuitry 920 is configured to exchange information, e.g., with other components inside or outside the apparatus 900 and the storage circuitry 940. Likewise, the device 900 may comprise means that is/are configured to provide the functionality of the device 900.

The components of the device 900 are defined as component means, which may correspond to, or implemented by, the respective structural components of the apparatus 900. For example, the device 900 of FIG. 9 comprises means for processing 930, which may correspond to or be implemented by the processing circuitry 930, means for communicating 920, which may correspond to or be implemented by the interface circuitry 920, and (optional) means for storing information 940, which may correspond to or be implemented by the storage circuitry 940. In the following, the functionality of the device 900 is illustrated with respect to the apparatus 900. Features described in connection with the apparatus 900 may thus likewise be applied to the corresponding device 900.

In general, the functionality of the processing circuitry 930 or means for processing 930 may be implemented by the processing circuitry 930 or means for processing 930 executing machine-readable instructions. Accordingly, any feature ascribed to the processing circuitry 930 or means for processing 930 may be defined by one or more instructions of a plurality of machine-readable instructions. The apparatus 900 or device 900 may comprise the machine-readable instructions, e.g., within the storage circuitry 940 or means for storing information 940.

The interface circuitry 920 or means for communicating 920 may correspond to one or more inputs and/or outputs for receiving and/or transmitting information, which may be in digital (bit) values according to a specified code, within a module, between modules or between modules of different entities. For example, the interface circuitry 920 or means for communicating 920 may comprise circuitry configured to receive and/or transmit information.

For example, the processing circuitry 930 or means for processing 930 may be implemented using one or more processing units, one or more processing devices, any means for processing, such as a processor, a computer or a programmable hardware component being operable with accordingly adapted software. In other words, the described function of the processing circuitry 930 or means for processing 930 may as well be implemented in software, which is then executed on one or more programmable hardware components.

For example, the storage circuitry 940 or means for storing information 940 may comprise at least one element of the group of a computer readable storage medium, such as a magnetic or optical storage medium, e.g., a hard disk drive, a flash memory, Floppy-Disk, Random Access Memory (RAM), Read Only Memory (ROM), Programmable Read Only Memory (PROM), Erasable Programmable Read Only Memory (EPROM), an Electronically Erasable Programmable Read Only Memory (EEPROM), or a network storage.

For example, the apparatus 900 may implement or include a chassis fuse controller that manages configuration data during warm reset operations. The chassis fuse controller may be implemented by the processing circuitry 930 executing firmware or control logic, or the chassis fuse controller may be the apparatus 900 itself when the apparatus 900 is integrated within the semiconductor device. The apparatus 900 may in some examples be integrated as part of the semiconductor device, implemented as a controller, management unit, or configuration subsystem within the semiconductor die of the semiconductor device. The apparatus 900 may be located within an always-on (AON) power domain of the semiconductor device, where the AON power domain remains powered and retains state during warm reset events. The apparatus 900 may alternatively be implemented as a separate controller chip or management processor external to the semiconductor device and connected to the semiconductor device through package-level interconnects or board-level communication interfaces.

For example, the apparatus 900 may be connected to the non-volatile OTP memory 950 and the non-volatile rewritable memory 660 that are part of or associated with the semiconductor device. The apparatus 900 may access the non-volatile OTP memory 950 and the non-volatile rewritable memory 960 through the interface circuitry 920. The connection between the apparatus 900 and the non-volatile OTP memory 950 may be implemented through dedicated on-die signal paths when the apparatus 900 and the non-volatile OTP memory 950 are both integrated on the same semiconductor die of the semiconductor device. The apparatus 900 may sense or read fuse values from the non-volatile OTP memory 950 through fuse sensing circuits during recovery sequences. The connection between the apparatus 900 and the non-volatile rewritable memory 960 may be implemented through the interface circuitry 920 using communication protocols such as SPI or I2C. The apparatus 900 may be connected to a volatile memory of the semiconductor device that is within the AON power domain, where the volatile memory stores the working copy of configuration values. The volatile memory may be the storage circuitry 940 of the apparatus 900, or the volatile memory may be separate SRAM accessible to the apparatus 900 through on-die memory buses or fabric interconnects. The volatile memory within the AON power domain may retain stored data during warm reset events because the AON power domain remains powered.

The processing circuitry 130 is configured, in response to receiving an indication of a warm reset exit of the semiconductor device, to validate an integrity of a working copy of configuration values retained in a volatile memory within an always-on (AON) power domain of the semiconductor device. For example, a warm reset exit of the semiconductor device may be an event where the semiconductor device exits from a warm reset state and resumes operation. A warm reset may be a reset operation where the semiconductor device is reset or reinitialized without completely removing power from the semiconductor device. The warm reset may differ from a cold boot sequence in that certain power domains of the semiconductor device remain powered during the warm reset. The warm reset may reset functional components and operational logic while preserving state in the AON power domain. The warm reset exit may be the point at which the reset condition is de-asserted and the semiconductor device begins resuming normal operation. The indication of the warm reset exit may be a signal, status bit, or event notification that informs the apparatus 900 that the semiconductor device has exited the warm reset state.

The validation of the integrity may be a process of checking whether the working copy of configuration values retained in the volatile memory is still valid, uncorrupted, and safe to use. The validation may determine whether the retained working copy has maintained data integrity during the warm reset event or whether the retained working copy has become corrupted or invalid. The working copy may be retained in the volatile memory within the AON power domain because the AON power domain remains powered during the warm reset, allowing the volatile memory to preserve its contents. For example, the validation of the integrity of the working copy may comprise performing at least one of a cyclic redundancy check, a version check, and an epoch check. A cyclic redundancy check (CRC) may be a mathematical error-detection algorithm that computes a checksum value based on the data content of the working copy and compares the computed checksum against a previously stored checksum to detect data corruption. The CRC may identify bit errors or data corruption that may have occurred in the volatile memory during the warm reset event. A version check may verify that the working copy corresponds to an expected version number or revision identifier. The version check may ensure that the working copy has not been inadvertently overwritten or replaced with an outdated or incorrect version of configuration data. An epoch check may verify that the working copy belongs to the current operational epoch or lifecycle phase of the semiconductor device. The epoch check may use epoch counters or epoch identifiers to ensure that the retained working copy is still valid for the current device state and has not become obsolete due to lifecycle transitions or security updates.

For example, the processing circuitry 930 may perform one or more of these validation checks by reading the working copy from the volatile memory and applying the respective checking algorithms. The processing circuitry 930 may compute a CRC value over the working copy and compare the computed CRC value against a stored CRC value that was calculated during the prior cold boot sequence when the working copy was initially created. The processing circuitry 930 may read a version field or epoch field from the working copy and compare the version field or epoch field against expected values stored in registers or non-volatile memory. The validation may succeed if all performed checks pass, indicating that the retained working copy is valid and can be used without re-sensing and re-patching. The validation may fail if any check detects an error, corruption, version mismatch, or epoch mismatch, indicating that the retained working copy cannot be trusted and a recovery sequence must be initiated.

For example, the volatile memory within the AON power domain may be the storage circuitry 940 of the apparatus 900, or the volatile memory may be separate SRAM accessible to the apparatus 900 through on-die memory buses or fabric interconnects. The volatile memory may store the working copy of configuration values that was created and patched during the prior cold boot sequence. The volatile memory may be integrated on the semiconductor die of the semiconductor device within the AON power domain.

For example, the AON power domain may be an always-on power domain that is a section or region of the semiconductor device that remains continuously powered even during warm reset events. The AON power domain may be distinguished from other power domains of the semiconductor device that may be powered down or reset during warm reset operations. The AON power domain may receive continuous power supply to preserve critical state information, configuration data, and control logic during reset events. The apparatus 900 and the volatile memory storing the working copy may both reside within the AON power domain, ensuring that the apparatus 900 remains operational and the working copy remains retained when the warm reset occurs. The retention of the working copy in the volatile memory within the AON power domain may eliminate the need to re-sense configuration data from the non-volatile OTP memory and re-patch the working copy from the second set of configuration data during warm reset exit, improving reset recovery time compared to cold boot sequences.

For example, the working copy may be a runtime version of configuration values stored in the volatile memory that was created during a prior cold boot sequence of the semiconductor device. The working copy was previously patched based on the second set of configuration data during the prior cold boot sequence. For example, the working copy was initially loaded with values from the first set of configuration data stored in the non-volatile OTP memory and then modified through read-modify-write operations using profile-specific operational parameters from the second set of configuration data. The patching during the prior cold boot sequence may have been performed by an apparatus such as apparatus 600 as described with regards to FIG. 5, using an SG-DMA engine to apply patch data derived from the second set of configuration data. The working copy may serve as the active configuration data that functional components of the semiconductor device read to determine their operational parameters. The working copy may remain intact in the volatile memory within the AON power domain during the warm reset because the AON power domain maintains power, preserving the working copy without requiring re-creation.

For example, the working copy retained in the volatile memory was initially loaded with values from the first set of configuration data. The first set of configuration data may comprise at least one parameter selected from a group consisting of a device identifier, a maximum hardware operational frequency, a maximum operational voltage, and a maximum thermal threshold. The first set of configuration data may be stored in the non-volatile OTP memory and may contain the immutable safety-critical parameters and device identification that form the foundation of the working copy. During the prior cold boot sequence, a chassis fuse controller or sensing circuitry may have read the first set of configuration data from the non-volatile OTP memory and written these values to the volatile memory to create the initial working copy. The profile-specific operational parameters from the second set of configuration data may then have been applied as patches to this initial working copy, creating a combined configuration state. The retained working copy that is being validated during warm reset exit may therefore contain both the original values from the first set of configuration data and the modifications from the second set of configuration data.

For example, the second set of configuration data may comprise at least one parameter selected from a group consisting of a product-specific operational frequency, a power budget, a number of enabled processing cores, a feature enablement flag, and an export-control parameter. The second set of configuration data may contain the profile-specific operational parameters that were used to patch the working copy during the prior cold boot sequence. The second set of configuration data may be stored in the non-volatile rewritable memory and may define the operational characteristics for the specific semiconductor device configuration profile or product variant. The patch data that was applied to create the working copy during the prior cold boot sequence may have been derived from these profile-specific operational parameters in the second set of configuration data. The working copy may therefore contain a combination of immutable safety-critical parameters from the first set of configuration data and flexible profile-specific operational parameters from the second set of configuration data, representing the complete configuration state that was established during the prior cold boot sequence and is now being validated during the warm reset exit.

The processing circuitry 130 is further configured, in response to receiving an indication of a warm reset exit of the semiconductor device, upon successful validation of the retained working copy cause a readiness signal to be asserted to enable one or more functional components of the semiconductor device to access the retained working copy without re-patching from the second set of configuration data. The readiness signal may be a control signal that indicates to the functional components of the semiconductor device that the working copy of configuration values is ready for access. The readiness signal may act as a synchronization mechanism that coordinates between the validation process performed by the processing circuitry 930 and the functional components that need to read configuration values during warm reset exit. The successful validation of the retained working copy may comprise that the integrity checks such as CRC, version check, and epoch check have all passed, confirming that the retained working copy is valid and uncorrupted.

The assertion of the readiness signal may enable the one or more functional components to access the retained working copy without requiring the apparatus 900 to re-sense configuration data from the non-volatile OTP memory or re-patch the working copy from the second set of configuration data in the non-volatile rewritable memory. The re-patching may be a process of repeating the read-modify-write operations that were performed during the prior cold boot sequence to apply profile-specific operational parameters from the second set of configuration data to the working copy. The avoidance of re-patching may significantly reduce the time required for warm reset exit compared to a cold boot sequence, because the working copy already contains the patched configuration values from the prior cold boot and does not need to be reconstructed.

For example, the one or more functional components of the semiconductor device may be IP blocks, processing cores, execution units, graphics engines, memory controllers, security modules, or other hardware elements that require configuration parameters to operate correctly. The functional components may include graphics processing units (GT), media processing engines, memory physical layer controllers (DDR PHY), and other functional blocks within the semiconductor device. The functional components may monitor the readiness signal and may wait until the readiness signal is asserted before attempting to read configuration values from the retained working copy in the volatile memory. The readiness signal may comprise a gating bit that acts as a barrier to prevent the one or more functional components from accessing the working copy prior to the successful validation. The gating bit may be a single bit flag, register bit, or hardware signal line that controls access to the retained working copy. The gating bit may implement a binary access control mechanism where a first state prevents access and a second state permits access. The gating bit may be cleared or set to a blocking state at the beginning of the warm reset exit sequence before validation occurs. The gating bit may act as a barrier by blocking the functional components from reading the retained working copy until the processing circuitry 930 completes validation and sets the gating bit to a permissive state. The barrier function may prevent functional components from accessing potentially corrupted configuration data if the validation were to fail.

For example, causing the readiness signal to be asserted may comprise re-exposing one or more latched registers to the one or more functional components. The latched registers may be receiver registers or configuration registers that hold configuration values for access by the functional components. The re-exposing may refresh or update the visibility of the retained working copy to the functional components after validation is complete. During the warm reset event or during the validation process, access to the latched registers may be blocked or gated to prevent the functional components from reading potentially inconsistent data. The re-exposing may involve updating register visibility, enabling read access paths, or refreshing register contents from the retained working copy in the volatile memory. The re-exposing may ensure that the functional components receive a consistent and validated view of the configuration data when they access the latched registers. After the re-exposing and assertion of the readiness signal, the functional components may perform parallel pull operations to read their required configuration values from the latched registers, similar to the process described for cold boot sequences. The gating bit may be set to the permissive state as part of or following the re-exposing operation, allowing the functional components to proceed with reading their configuration parameters and completing their initialization during warm reset exit.

The processing circuitry 130 is further configured, in response to receiving an indication of a warm reset exit of the semiconductor device, upon failing of the validation of the retained working copy initiate a recovery sequence comprising a re-sensing of configuration data from a non-volatile OTP memory. The failing of the validation may occur when one or more of the integrity checks performed on the retained working copy detect errors, corruption, version mismatches, or epoch mismatches. The failing of the validation may indicate that the retained working copy cannot be trusted and should not be used by the functional components. The failing of the validation and the successful validation may be mutually exclusive outcomes of the validation process. The processing circuitry 930 may perform the validation checks and then follow one of two alternative paths based on the validation result: upon successful validation, the processing circuitry 930 causes the readiness signal to be asserted to enable access to the retained working copy, or upon failing of the validation, the processing circuitry 930 initiates the recovery sequence. The two paths may be exclusive alternatives where only one path is executed depending on the validation outcome.

For example, the recovery sequence may be a fallback process that reconstructs a valid working copy when the retained working copy is determined to be invalid or corrupted. The recovery sequence may comprise re-sensing configuration data from the non-volatile OTP memory. The re-sensing may involve reading the first set of configuration data from the non-volatile OTP memory using fuse sensing circuits, similar to the sensing operations performed during a cold boot sequence. The re-sensing may reload the safety-critical parameters and device identifier from the non-volatile OTP memory into the volatile memory to create a fresh working copy. The recovery sequence may restore the semiconductor device to a known good configuration state by retrieving immutable configuration data from the non-volatile OTP memory that cannot be corrupted. The initiation of the recovery sequence may involve the processing circuitry 930 triggering fuse sensing operations, managing data transfers from the non-volatile OTP memory to the volatile memory, and coordinating the reconstruction of the working copy.

For example, the recovery sequence initiated upon the validation failing may comprise instructing a re-patching of the working copy based on the second set of configuration data.

The re-patching may be the process of applying profile-specific operational parameters from the second set of configuration data to the working copy through read-modify-write operations, similar to the patching operations performed during a cold boot sequence. After the re-sensing loads the first set of configuration data from the non-volatile OTP memory into the volatile memory, the processing circuitry 930 may instruct re-patching operations to apply the second set of configuration data. The re-patching may be performed by an apparatus such as apparatus 600, where a trusted firmware agent reads the second set of configuration data from the non-volatile rewritable memory, generates machine-readable descriptors, and provides the descriptors to an SG-DMA engine that performs read-modify-write operations on the working copy. The recovery sequence may therefore fully reconstruct the working copy by combining the re-sensed first set of configuration data with the re-patched second set of configuration data, creating a valid working copy equivalent to what would be created during a cold boot sequence. After the recovery sequence completes, the processing circuitry 930 may then cause the readiness signal to be asserted to enable the functional components to access the reconstructed working copy.

For example, the apparatus 900 may enable rapid recovery from warm reset events while maintaining configuration data integrity and security through validation and fallback mechanisms. The apparatus 900 may allow the semiconductor device to resume operation quickly after warm reset by reusing the retained working copy in the volatile memory within the AON power domain without requiring time-consuming re-sensing and re-patching operations when the retained working copy passes validation. The apparatus 900 may provide robustness and fault tolerance by validating the integrity of the retained working copy through CRC checks, version checks, and epoch checks before allowing functional components to access the retained working copy. The apparatus 900 may enable safe operation by using the gating bit as a barrier that prevents functional components from accessing potentially corrupted configuration data until validation is complete. The apparatus 900 may provide a recovery mechanism that automatically reconstructs a valid working copy through re-sensing from the non-volatile OTP memory and re-patching from the second set of configuration data when validation fails, ensuring that the semiconductor device can always reach a known good configuration state. The apparatus 900 may allow power savings by maintaining the working copy in the AON power domain rather than requiring full cold boot sequences for every reset event. The apparatus 900 may enable faster warm reset exit times compared to cold boot sequences by eliminating unnecessary configuration operations when the retained working copy is valid, while maintaining the same level of configuration security and correctness as cold boot sequences through the validation and recovery mechanisms.

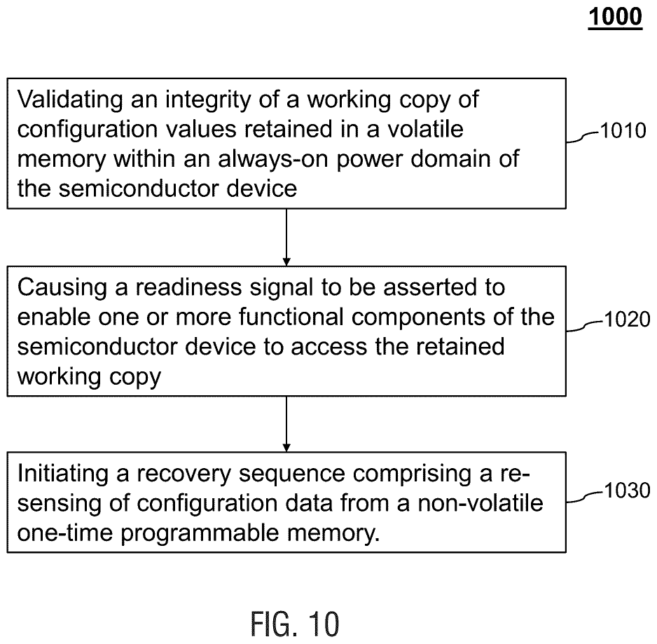

Further details and aspects are mentioned in connection with the examples described above or below. The example shown in FIG. 9 may include one or more optional additional features corresponding to one or more aspects mentioned in connection with the proposed concept or one or more examples described above (e.g., FIGS. 1-8) or below (e.g., FIGS. 10-12) .

FIG. 10 illustrates a flowchart of an example of a method 1000 for performing a warm reset exit on a semiconductor device. The method 100 may, for instance, be performed by an apparatus as described herein, such as apparatus 900.

The method 1000 comprises in response to receiving an indication of a warm reset exit of the semiconductor device validating 1010 an integrity of a working copy of configuration values retained in a volatile memory within an always-on, AON, power domain of the semiconductor device. The working copy was previously patched based on a second set of configuration data during a prior cold boot sequence.

The method 1000 further comprises in response to receiving an indication of a warm reset exit of the semiconductor device upon successful validation of the retained working copy causing 1020 a readiness signal to be asserted to enable one or more functional components of the semiconductor device to access the retained working copy without re-patching from the second set of configuration data.

The method 1000 further comprises in response to receiving an indication of a warm reset exit of the semiconductor device upon failing of the validation of the retained working copy initiating 1030 a recovery sequence comprising a re-sensing of configuration data from a non-volatile one-time programmable (OTP) memory.

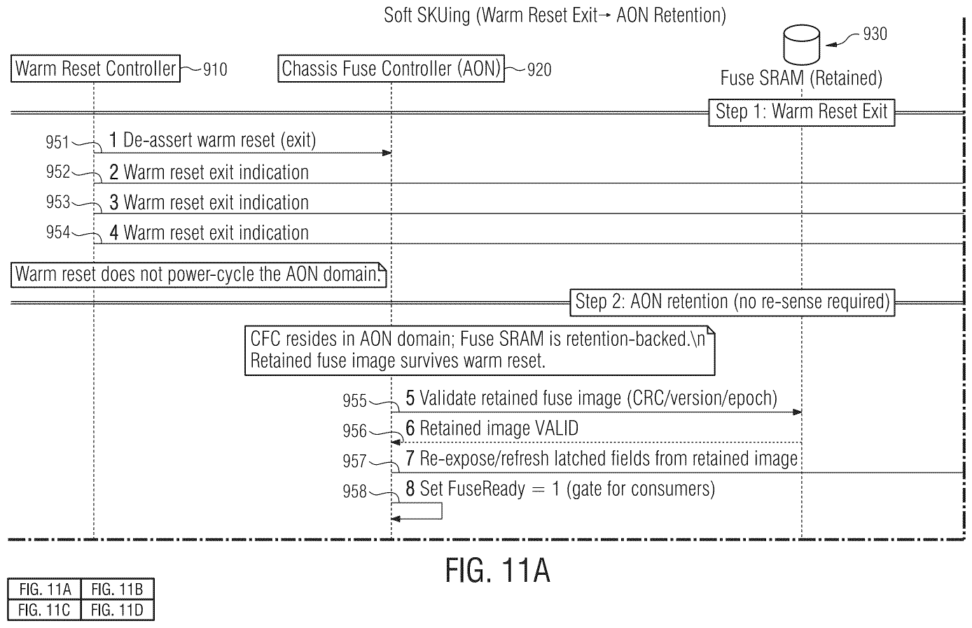

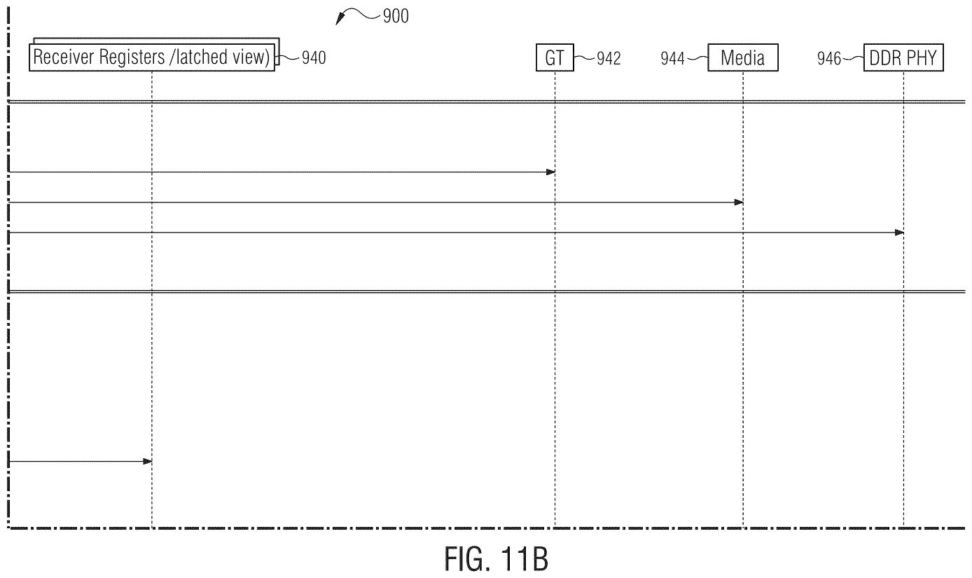

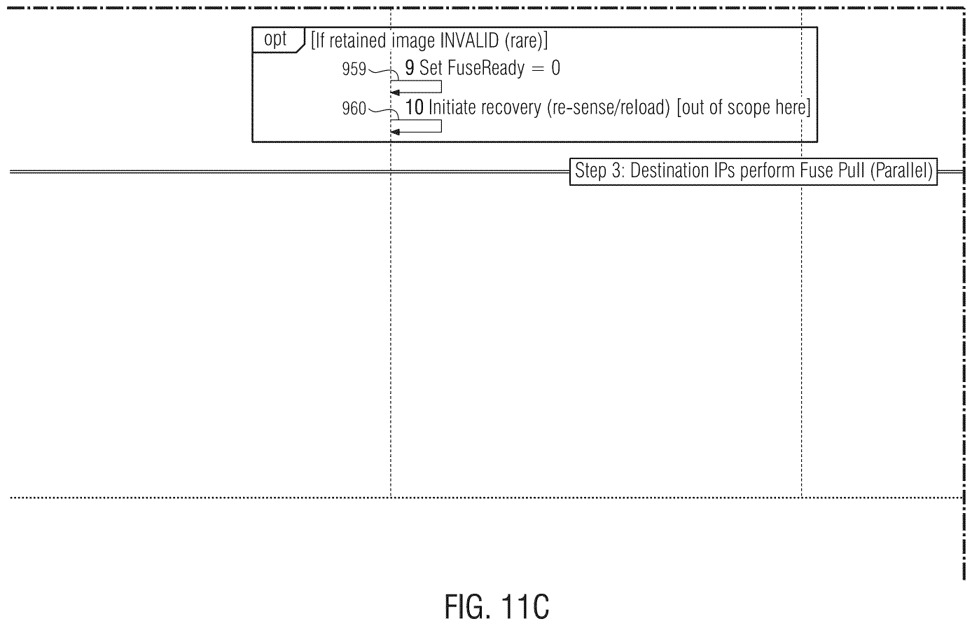

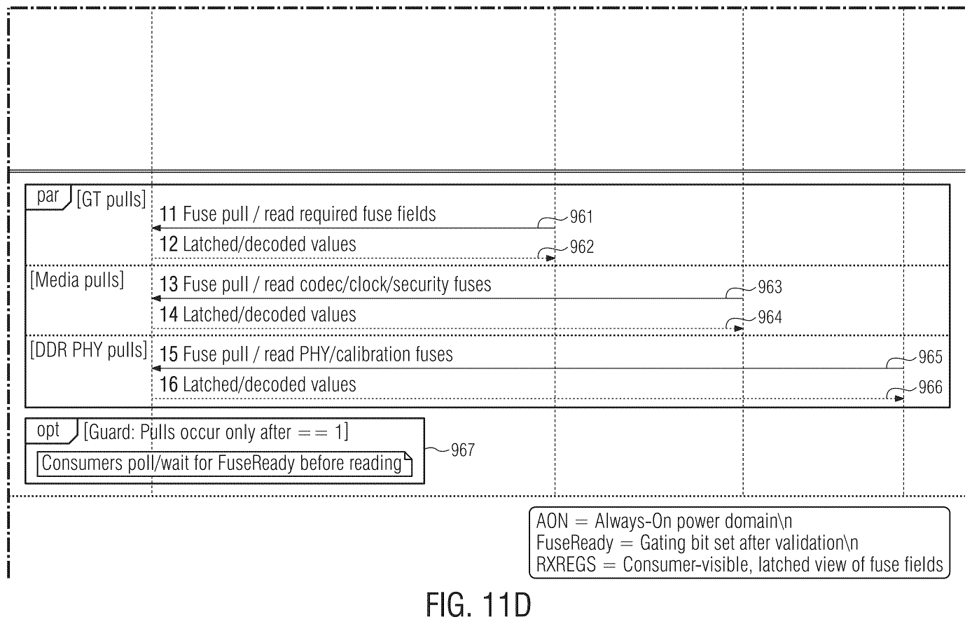

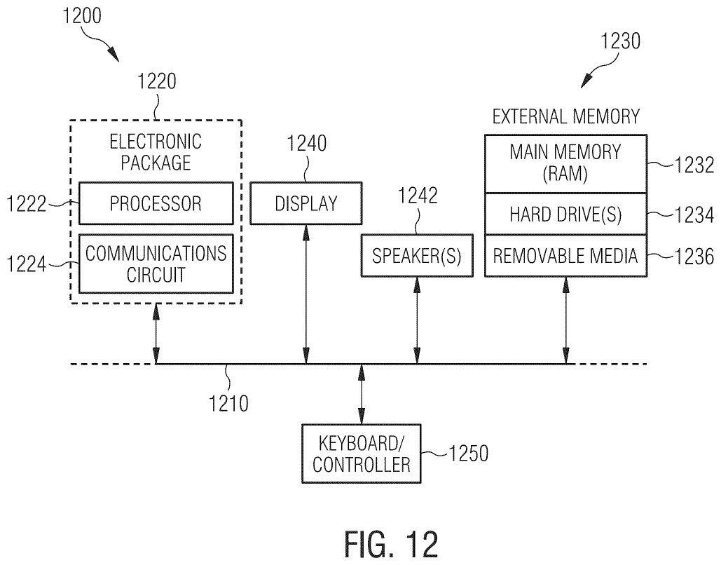

Further details and aspects are mentioned in connection with the examples described above or below. The example shown in FIG. 10 may include one or more optional additional features corresponding to one or more aspects mentioned in connection with the proposed concept or one or more examples described above (e.g., FIGS. 1-9) or below (e.g., FIGS. 11A-12) .

FIGS. 11A-11D, which form a single figure, illustrate an example flow 1100 for a warm reset exit sequence of a semiconductor device with AON (always-on) retention. The flow 1100 may represent a configuration recovery flow that leverages retained configuration data in the AON power domain to enable rapid reset recovery without requiring re-sensing from non-volatile memories. In a reset case (warm/hot) without power loss, the Fuse SRAM (volatile memory, storage circuitry 940) and firmware reside in the AON domain, and a re-download of soft configuration (second set of configuration data) and update to Fuse SRAM is not required.

The flow 1100 shows interactions between a Warm Reset Controller 1110, a Chassis Fuse Controller (AON) 1120 (for example apparatus 900 or processing circuitry 930 thereof), Fuse SRAM (Retained) 1130 (for example the volatile memory, storage circuitry 940), Receiver Registers (latched view) 1140 (latched registers), and functional components including GT 1142 (graphics processing unit), Media 1144 (media processing engine), and DDR PHY 1146 (memory physical layer controller).

The flow 1100 begins with Step 1, Warm Reset Exit during which warm reset exit indications are propagated through the system. At step 1151, the warm reset is de-asserted (exit). At step 1152, a warm reset exit indication is transmitted from the Warm Reset Controller 1110. At step 1153, a warm reset exit indication is transmitted to the Receiver Registers 1140. At step 1154, a warm reset exit indication is transmitted to the functional components 1142, 1144, 1146. The warm reset does not power-cycle the AON domain, meaning that components within the AON power domain maintain their state and retained data throughout the warm reset event.

The flow 1100 continues with Step 2, AON retention (no re-sense required). The Chassis Fuse Controller (AON) 1120 resides in the AON domain, and the Fuse SRAM (Retained) 1130 is retention-backed, meaning the retained fuse image (working copy of configuration values) survives the warm reset. At step 1155, the Chassis Fuse Controller (AON) 1120 validates the retained fuse image through integrity checks such as CRC (cyclic redundancy check), version check, and epoch check. At step 1156, if the retained image is determined to be VALID, the flow proceeds along the main path. At step 1157, the Chassis Fuse Controller (AON) 1120 re-exposes or refreshes latched fields from the retained image to the Receiver Registers 1140, making the retained working copy visible to the functional components. At step 1158, the Chassis Fuse Controller (AON) 1120 sets FuseReady=1, which serves as a gating bit or barrier for consumers (functional components), thereby asserting the readiness signal to enable the functional components to access the retained working copy. In the optional path, if the retained image is INVALID (a rare occurrence), the flow 1100 follows an alternative recovery path. At step 1159, the Chassis Fuse Controller (AON) 1120 sets FuseReady=0, blocking access to the potentially corrupted working copy. At step 1160, the Chassis Fuse Controller (AON) 1120 initiates recovery operations including re-sense and reload, which comprise re-sensing configuration data from the non-volatile OTP memory and re-patching the working copy based on the second set of configuration data from the non-volatile rewritable memory.

The flow 1100 concludes with Step 3, Destination IPs perform Fuse Pull (Parallel). The functional components (GT 1142, Media 1144, DDR PHY 1146) perform parallel pull operations to read their required configuration values from the Receiver Registers 1140. At step 1161, the GT pulls or reads required fuse fields (configuration values). At step 1162, the GT latches and decodes the pulled values into internal registers. At step 1163, the Media engine pulls or reads codec, clock, and security-related fuses (configuration parameters). At step 1164, the Media engine latches and decodes the pulled values. At step 1165, the DDR PHY pulls or reads PHY calibration fuses (memory timing and calibration parameters). At step 1166, the DDR PHY latches and decodes the pulled values. At step 1167, a guard condition ensures that pulls occur only after FuseReady equals 1, meaning consumers poll or wait for the readiness signal (FuseReady, gating bit) before reading configuration values.

The flow 1100 enables rapid warm reset recovery by reusing the retained working copy when validation succeeds, eliminating the time-consuming operations of re-sensing from the non-volatile OTP memory and re-patching from the second set of configuration data. The flow 1100 provides robustness through validation mechanisms and a recovery fallback path when the retained working copy is determined to be invalid.

Further details and aspects are mentioned in connection with the examples described above or below. The example shown in FIGS. 11A-11D may include one or more optional additional features corresponding to one or more aspects mentioned in connection with the proposed concept or one or more examples described above (e.g., FIGS. 1-10) or below (e.g., FIG. 12).

FIG. 12 illustrates an example of a block diagram of an electronic apparatus 1200 incorporating at least one electronic assembly 100, 200, 400 or 600 and/or methods 300 or 700 described herein. Electronic apparatus 1200 is merely one example of an electronic apparatus in which forms of the electronic assemblies 100, 200, 400 or 600 and/or methods 300 or 700 described herein may be used. Examples of an electronic apparatus 1200 include, but are not limited to, personal computers, tablet computers, mobile telephones, game devices, MP3 or other digital music players, etc. In this example, electronic apparatus 1200 comprises a data processing system that includes a system bus 1210 to couple the various components of the electronic apparatus 1200. System bus 1210 provides communications links among the various components of the electronic apparatus 1200 and may be implemented as a single bus, as a combination of busses, or in any other suitable manner.

An electronic assembly 1220 as describe herein may be coupled to system bus 1210. The electronic assembly 1220 may include any circuit or combination of circuits. In one embodiment, the electronic assembly 1220 includes a processor 1222 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 1220 are a custom circuit, an application-specific integrated circuit (ASIC), or the like, such as, for example, one or more circuits (such as a communications circuit 1224) for use in wireless devices like mobile telephones, tablet computers, laptop computers, two-way radios, and similar electronic systems. The IC can perform any other type of function.

The electronic apparatus 1200 may also include an external memory 1230, which in turn may include one or more memory elements suitable to the particular application, such as a main memory 1232 in the form of random access memory (RAM), one or more hard drives 1234, and/or one or more drives that handle removable media 1236 such as compact disks (CD), flash memory cards, digital video disk (DVD), and the like.

The electronic apparatus 1200 may also include a display device 1240, one or more speakers 1242, and a keyboard and/or controller 1250, which can include a mouse, trackball, touch screen, voice-recognition device, or any other device that permits a system user to input information into and receive information from the electronic apparatus 1200.

Further details and aspects are mentioned in connection with the examples described above. The example shown in FIG. 12 may include one or more optional additional features corresponding to one or more aspects mentioned in connection with the proposed concept or one or more examples described above (e.g., FIGS. 1-11) .

In the following, some examples of the proposed technique are presented:

An example (e.g., example 1) relates to a non-transitory computer-readable medium storing instructions that, when executed by a processing circuitry, causing the processing circuitry to perform a method comprising receiving configuration inputs for a target semiconductor device, the configuration inputs comprising a device identifier, one or more safety-critical parameters, and profile-specific operational parameters for one or more semiconductor device configuration profiles, and generating a first set of configuration data for programming into a non-volatile one-time programmable, OTP, memory of the target semiconductor device, the first set of configuration data comprising the safety-critical parameters and the device identifier, and generating a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state

Another example (e.g., example 2) relates to a previous example (e.g., example 1) or to any other example, further comprising that the cryptographic signature is calculated based on at least the profile-specific operational parameters or the manifest.

Another example (e.g., example 3) relates to a previous example (e.g., one of the examples 1 to 2) or to any other example, further comprising that the device identifier is a hardware-based unique identifier comprising at least one of a PCIe device identifier, a fused serial number, a Media Access Control, MAC, address, or an identifier derived from a Physical Unclonable Function, PUF.

Another example (e.g., example 4) relates to a previous example (e.g., one of the examples 1 to 3) or to any other example, further comprising that the method further comprises transmitting the generated first set of configuration data to a programming interface for the non-volatile OTP memory, and transmitting the generated second set of configuration data to a programming interface for the non-volatile rewritable memory.

Another example (e.g., example 5) relates to a previous example (e.g., one of the examples 1 to 4) or to any other example, further comprising that the second set of configuration data is redundantly stored across a plurality of logical boot partitions on the non-volatile rewritable memory.

Another example (e.g., example 6) relates to a previous example (e.g., one of the examples 1 to 5) or to any other example, further comprising that the safety-critical parameters comprise at least one of a maximum hardware operational frequency, a maximum operational voltage, a maximum thermal threshold or permanent disablement data for one or more hardware blocks.

Another example (e.g., example 7) relates to a previous example (e.g., one of the examples 1 to 6) or to any other example, further comprising that the profile-specific operational parameters comprise at least one of a product-specific operational frequency that is constrained by a corresponding safety-critical maximum hardware operational frequency, a power budget, a number of enabled processing cores or execution units, a feature enablement flag or export-control parameter.

Another example (e.g., example 8) relates to a previous example (e.g., one of the examples 1 to 7) or to any other example, further comprising that the configuration inputs further comprise system-level operational parameters, and wherein the method further comprises integrating the system-level operational parameters into the second set of configuration data.

Another example (e.g., example 9) relates to a previous example (e.g., one of the examples 1 to 8) or to any other example, further comprising that the second set of configuration data is structured to include scatter-gather descriptors for use by a direct memory access, DMA, engine on the target semiconductor device.

Another example (e.g., example 10) relates to a previous example (e.g., one of the examples 1 to 9) or to any other example, further comprising that the cryptographic signature is an eXtended Merkle Signature Scheme, XMSS.

Another example (e.g., example 11) relates to a previous example (e.g., one of the examples 1 to 10) or to any other example, further comprising that target semiconductor device comprises at least one of a System-on-a-Chip, SoC, a discrete graphics processing unit, dGPU, a central processing unit, CPU, or an accelerator.

An example (e.g., example 12) relates to an apparatus storing configuration data of a target semiconductor device, comprising a non-volatile one-time programmable, OTP, memory storing a first set of configuration data for the target semiconductor device, the first set of configuration data comprising a device identifier and safety-critical parameters, and a non-volatile rewritable memory storing a second set of configuration data for the target semiconductor device, the second set of configuration data comprising profile-specific operational parameters, a cryptographic signature, and a manifest, wherein the manifest is configured to bind the second set of configuration data to the device identifier and to enforce immutability of the second set of configuration data upon the system reaching a predefined lifecycle state.

Another example (e.g., example 13) relates to a previous example (e.g., example 12) or to any other example, further comprising that the second set of configuration data is redundantly stored across a plurality of logical boot partitions on the non-volatile rewritable memory.

Another example (e.g., example 14) relates to a previous example (e.g., one of the examples 12 to 13) or to any other example, further comprising that the device identifier stored in the OTP memory is a hardware-based unique identifier comprising at least one of a PCIe device identifier, a fused serial number, a Media Access Control, MAC, address, or an identifier derived from a Physical Unclonable Function, PUF.

Another example (e.g., example 15) relates to a previous example (e.g., one of the examples 12 to 14) or to any other example, further comprisinga direct memory access DMA engine, wherein the DMA is configured to use scatter-gather descriptors included in the second set of configuration data to patch a working copy of configuration values in a volatile memory.

An example (e.g., example 16) relates to an apparatus for performing a cold boot sequence on a semiconductor device comprising interface circuitry, machine-readable instructions and processing circuitry to execute the machine-readable instructions to during a cold boot sequence of the semiconductor device receive one or more machine-readable descriptors, which are generated based on a second set of configuration data of the semiconductor device stored in a non-volatile rewritable memory of the semiconductor device, perform a read-modify-write operation on a working copy of configuration values stored in a volatile memory of the semiconductor device based on patch data included in the one or more descriptors, wherein the working copy is initially loaded with values from a first set of configuration data of the semiconductor device stored in a non-volatile one-time programmable, OTP, memory of the semiconductor device, generate a completion signal for causing a readiness signal to be asserted to enable one or more functional components of the semiconductor device to access the modified working copy.

Another example (e.g., example 17) relates to a previous example (e.g., example 16) or to any other example, further comprising that the processing circuitry comprises a scatter-gather direct memory access, SG-DMA, engine, and wherein the SG-DMA engine is configured to perform the read-modify-write operation.

Another example (e.g., example 18) relates to a previous example (e.g., one of the examples 16 to 17) or to any other example, further comprising that the one or more machine-readable descriptors comprise at least one of a physical address in the volatile memory, a data mask, or a data length.

Another example (e.g., example 19) relates to a previous example (e.g., one of the examples 16 to 18) or to any other example, further comprising that the read-modify-write operation is configured to write the modified one or more configuration values to a plurality of disaggregated memory locations within the volatile memory to reduce fabric congestion.

Another example (e.g., example 20) relates to a previous example (e.g., one of the examples 16 to 19) or to any other example, further comprising that the apparatus receives the one or more machine-readable descriptors from a trusted firmware agent executing on a controller of the semiconductor device.

Another example (e.g., example 21) relates to a previous example (e.g., one of the examples 16 to 20) or to any other example, further comprising that the patch data included in the one or more descriptors comprises profile-specific operational parameters derived from the second set of configuration data.

Another example (e.g., example 22) relates to a previous example (e.g., one of the examples 16 to 21) or to any other example, further comprising that the readiness signal comprises a gating bit that acts as a barrier for the one or more functional components.

Another example (e.g., example 23) relates to a previous example (e.g., one of the examples 16 to 22) or to any other example, further comprising that the first set of configuration data comprises at least one parameter selected from a group consisting of a device identifier, a maximum hardware operational frequency, a maximum operational voltage, and a maximum thermal threshold.

Another example (e.g., example 24) relates to a previous example (e.g., one of the examples 16 to 23) or to any other example, further comprising that the second set of configuration data comprises at least one parameter selected from a group consisting of a product-specific operational frequency, a power budget, a number of enabled processing cores, a feature enablement flag, and an export-control parameter.

An example (e.g., example 25) relates to an apparatus for performing a warm reset exit on a semiconductor device comprising interface circuitry, machine-readable instructions and processing circuitry to execute the machine-readable instructions to in response to receiving an indication of a warm reset exit of the semiconductor device validate an integrity of a working copy of configuration values retained in a volatile memory within an always-on, AON, power domain of the semiconductor device, wherein the working copy was previously patched based on a second set of configuration data during a prior cold boot sequence, upon successful validation of the retained working copy cause a readiness signal to be asserted to enable one or more functional components of the semiconductor device to access the retained working copy without re-patching from the second set of configuration data, and upon failing of the validation of the retained working copy initiate a recovery sequence comprising a re-sensing of configuration data from a non-volatile one-time programmable, OTP, memory.

Another example (e.g., example 26) relates to a previous example (e.g., example 25) or to any other example, further comprising that the working copy retained in the volatile memory was initially loaded with values from a first set of configuration data, the first set comprising at least one parameter selected from a group consisting of a device identifier, a maximum hardware operational frequency, a maximum operational voltage, and a maximum thermal threshold.

Another example (e.g., example 27) relates to a previous example (e.g., one of examples 25 to 26) or to any other example, wherein the second set comprises at least one parameter selected from a group consisting of a product-specific operational frequency, a power budget, a number of enabled processing cores, a feature enablement flag, and an export-control parameter.

Another example (e.g., example 28) relates to a previous example (e.g., one of the examples 25 to 27) or to any other example, further comprising that to validate the integrity of the working copy comprises to perform at least one of a cyclic redundancy check, a version check, and an epoch check.

Another example (e.g., example 29) relates to a previous example (e.g., one of the examples 25 to 28) or to any other example, further comprising that the recovery sequence initiated upon the validation failing comprises instructing a re-patching of the working copy based on the second set of configuration data.

Another example (e.g., example 30) relates to a previous example (e.g., one of the examples 25 to 29) or to any other example, further comprising that causing the readiness signal to be asserted comprises re-exposing one or more latched registers to the one or more functional components.

Another example (e.g., example 31) relates to a previous example (e.g., one of the examples 25 to 30) or to any other example, further comprising that the readiness signal comprises a gating bit that acts as a barrier to prevent the one or more functional components from accessing the working copy prior to the successful validation.

An example (e.g., example 32) relates to an apparatus comprising interface circuitry, machine-readable instructions and processing circuitry to execute the machine-readable instructions to receive configuration inputs for a target semiconductor device, the configuration inputs comprising a device identifier, one or more safety-critical parameters, and profile-specific operational parameters for one or more semiconductor device configuration profiles, and generate a first set of configuration data for programming into a non-volatile one-time programmable, OTP, memory of the target semiconductor device, the first set of configuration data comprising the safety-critical parameters and the device identifier, and generate a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state.

Another example (e.g., example 33) relates to a previous example (e.g., example 32) or to any other example, further comprising that the cryptographic signature is calculated based on at least the profile-specific operational parameters or the manifest.

Another example (e.g., example 34) relates to a previous example (e.g., one of the examples 32 to 33) or to any other example, further comprising that the device identifier is a hardware-based unique identifier comprising at least one of a PCIe device identifier, a fused serial number, a Media Access Control, MAC, address, or an identifier derived from a Physical Unclonable Function, PUF.

Another example (e.g., example 35) relates to a previous example (e.g., one of the examples 32 to 34) or to any other example, further comprising that the processing circuitry is further to execute the machine-readable instructions to transmit the generated first set of configuration data to a programming interface for the non-volatile OTP memory, and transmit the generated second set of configuration data to a programming interface for the non-volatile rewritable memory.

Another example (e.g., example 36) relates to a previous example (e.g., one of the examples 32 to 35) or to any other example, further comprising that the second set of configuration data is configured to be redundantly stored across a plurality of logical boot partitions on the non-volatile rewritable memory.

Another example (e.g., example 37) relates to a previous example (e.g., one of the examples 32 to 36) or to any other example, further comprising that the safety-critical parameters comprise at least one of a maximum hardware operational frequency, a maximum operational voltage, a maximum thermal threshold or permanent disablement data for one or more hardware blocks.

Another example (e.g., example 38) relates to a previous example (e.g., one of the examples 32 to 37) or to any other example, further comprising that the profile-specific operational parameters comprise at least one of a product-specific operational frequency that is constrained by a corresponding safety-critical maximum hardware operational frequency, a power budget, a number of enabled processing cores or execution units, a feature enablement flag or export-control parameter.

Another example (e.g., example 39) relates to a previous example (e.g., one of the examples 32 to 38) or to any other example, further comprising that the configuration inputs further comprise system-level operational parameters, and wherein the processing circuitry is further to execute the machine-readable instructions to integrate the system-level operational parameters into the second set of configuration data.

Another example (e.g., example 40) relates to a previous example (e.g., one of the examples 32 to 39) or to any other example, further comprising that the second set of configuration data is structured to include scatter-gather descriptors for use by a direct memory access, DMA, engine on the target semiconductor device.

Another example (e.g., example 41) relates to a previous example (e.g., one of the examples 32 to 40) or to any other example, further comprising that the cryptographic signature is an extended Merkle Signature Scheme, XMSS.

Another example (e.g., example 42) relates to a previous example (e.g., one of the examples 32 to 41) or to any other example, further comprising that the target semiconductor device comprises at least one of a System-on-a-Chip, SoC, a discrete graphics processing unit, dGPU, a central processing unit, CPU, or an accelerator.

An example (e.g., example 43) relates to an apparatus comprising a processor circuitry configured to receive configuration inputs for a target semiconductor device, the configuration inputs comprising a device identifier, one or more safety-critical parameters, and profile-specific operational parameters for one or more semiconductor device configuration profiles, and generate a first set of configuration data for programming into a non-volatile one-time programmable, OTP, memory of the target semiconductor device, the first set of configuration data comprising the safety-critical parameters and the device identifier, and generate a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state.

An example (e.g., example 44) relates to a device comprising means for processing for receiving configuration inputs for a target semiconductor device, the configuration inputs comprising a device identifier, one or more safety-critical parameters, and profile-specific operational parameters for one or more semiconductor device configuration profiles, and generating a first set of configuration data for programming into a non-volatile one-time programmable, OTP, memory of the target semiconductor device, the first set of configuration data comprising the safety-critical parameters and the device identifier, and generating a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state.

An example (e.g., example 45) relates to a method comprising receiving configuration inputs for a target semiconductor device, the configuration inputs comprising a device identifier, one or more safety-critical parameters, and profile-specific operational parameters for one or more semiconductor device configuration profiles, and generating a first set of configuration data for programming into a non-volatile one-time programmable, OTP, memory of the target semiconductor device, the first set of configuration data comprising the safety-critical parameters and the device identifier, and generating a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state.

Another example (e.g., example 46) relates to a previous example (e.g., example 45) or to any other example, further comprising that the cryptographic signature is calculated based on at least the profile-specific operational parameters or the manifest.

Another example (e.g., example 47) relates to a previous example (e.g., one of the examples 45 to 46) or to any other example, further comprising that the device identifier is a hardware-based unique identifier comprising at least one of a PCle device identifier, a fused serial number, a Media Access Control, MAC, address, or an identifier derived from a Physical Unclonable Function, PUF.

Another example (e.g., example 48) relates to a previous example (e.g., one of the examples 45 to 47) or to any other example, further comprising transmitting the generated first set of configuration data to a programming interface for the non-volatile OTP memory, and transmitting the generated second set of configuration data to a programming interface for the non-volatile rewritable memory.

Another example (e.g., example 49) relates to a previous example (e.g., one of the examples 45 to 48) or to any other example, further comprising that the second set of configuration data is redundantly stored across a plurality of logical boot partitions on the non-volatile rewritable memory.

Another example (e.g., example 50) relates to a previous example (e.g., one of the examples 45 to 49) or to any other example, further comprising that the safety-critical parameters comprise at least one of a maximum hardware operational frequency, a maximum operational voltage, a maximum thermal threshold or permanent disablement data for one or more hardware blocks.

Another example (e.g., example 51) relates to a previous example (e.g., one of the examples 45 to 50) or to any other example, further comprising that the profile-specific operational parameters comprise at least one of a product-specific operational frequency that is constrained by a corresponding safety-critical maximum hardware operational frequency, a power budget, a number of enabled processing cores or execution units, a feature enablement flag or export-control parameter.

Another example (e.g., example 52) relates to a previous example (e.g., one of the examples 45 to 51) or to any other example, further comprising that the configuration inputs further comprise system-level operational parameters, and wherein the method further comprises integrating the system-level operational parameters into the second set of configuration data.

Another example (e.g., example 53) relates to a previous example (e.g., one of the examples 45 to 52) or to any other example, further comprising that the second set of configuration data is structured to include scatter-gather descriptors for use by a direct memory access, DMA, engine on the target semiconductor device.

Another example (e.g., example 54) relates to a previous example (e.g., one of the examples 45 to 53) or to any other example, further comprising that the cryptographic signature is an extended Merkle Signature Scheme, XMSS.

Another example (e.g., example 55) relates to a previous example (e.g., one of the examples 45 to 54) or to any other example, further comprising that the target semiconductor device comprises at least one of a System-on-a-Chip, SoC, a discrete graphics processing unit, dGPU, a central processing unit, CPU, or an accelerator.

Another example (e.g., example 56) relates to a computer program having a program code for performing the method of any one of examples 45 to 55 when the computer program is executed on a computer, a processor, or a programmable hardware component.

An example (e.g., example 57) relates to a method for performing a cold boot sequence on a semiconductor device, the method comprising during a cold boot sequence of the semiconductor device receiving one or more machine-readable descriptors, which are generated based on a second set of configuration data of the semiconductor device stored in a non-volatile rewritable memory of the semiconductor device, performing a read-modify-write operation on a working copy of configuration values stored in a volatile memory of the semiconductor device based on patch data included in the one or more descriptors, wherein the working copy is initially loaded with values from a first set of configuration data of the semiconductor device stored in a non-volatile one-time programmable, OTP, memory of the semiconductor device, generating a completion signal for causing a readiness signal to be asserted to enable one or more functional components of the semiconductor device to access the modified working copy.

Another example (e.g., example 58) relates to a previous example (e.g., example 57) or to any other example, further comprising that the read-modify-write operation is performed by a scatter-gather direct memory access, SG-DMA, engine.

Another example (e.g., example 59) relates to a previous example (e.g., one of the examples 57 to 58) or to any other example, further comprising that the one or more machine-readable descriptors comprise at least one of a physical address in the volatile memory, a data mask, or a data length.

Another example (e.g., example 60) relates to a previous example (e.g., one of the examples 57 to 59) or to any other example, further comprising that the read-modify-write operation writes the modified one or more configuration values to a plurality of disaggregated memory locations within the volatile memory to reduce fabric congestion.

Another example (e.g., example 61) relates to a previous example (e.g., one of the examples 57 to 60) or to any other example, further comprising that the one or more machine-readable descriptors are received from a trusted firmware agent executing on a controller of the semiconductor device.

Another example (e.g., example 62) relates to a previous example (e.g., one of the examples 57 to 61) or to any other example, further comprising that the patch data included in the one or more descriptors comprises profile-specific operational parameters derived from the second set of configuration data.

Another example (e.g., example 63) relates to a previous example (e.g., one of the examples 57 to 62) or to any other example, further comprising that the readiness signal comprises a gating bit that acts as a barrier for the one or more functional components.

Another example (e.g., example 64) relates to a previous example (e.g., one of the examples 57 to 63) or to any other example, further comprising that the first set of configuration data comprises at least one parameter selected from a group consisting of a device identifier, a maximum hardware operational frequency, a maximum operational voltage, and a maximum thermal threshold.

Another example (e.g., example 65) relates to a previous example (e.g., one of the examples 57 to 64) or to any other example, further comprising that the second set of configuration data comprises at least one parameter selected from a group consisting of a product-specific operational frequency, a power budget, a number of enabled processing cores, a feature enablement flag, and an export-control parameter.

An example (e.g., example 66) relates to a non-transitory computer-readable medium storing instructions that, when executed by a processing circuitry, cause the processing circuitry to perform a method for a cold boot sequence on a semiconductor device, the method comprising during a cold boot sequence of the semiconductor device receiving one or more machine-readable descriptors, which are generated based on a second set of configuration data of the semiconductor device stored in a non-volatile rewritable memory of the semiconductor device, performing a read-modify-write operation on a working copy of configuration values stored in a volatile memory of the semiconductor device based on patch data included in the one or more descriptors, wherein the working copy is initially loaded with values from a first set of configuration data of the semiconductor device stored in a non-volatile one-time programmable, OTP, memory of the semiconductor device, generating a completion signal for causing a readiness signal to be asserted to enable one or more functional components of the semiconductor device to access the modified working copy.

An example (e.g., example 67) relates to an apparatus comprising a processor circuitry configured to during a cold boot sequence of the semiconductor device receive one or more machine-readable descriptors, which are generated based on a second set of configuration data of the semiconductor device stored in a non-volatile rewritable memory of the semiconductor device, perform a read-modify-write operation on a working copy of configuration values stored in a volatile memory of the semiconductor device based on patch data included in the one or more descriptors, wherein the working copy is initially loaded with values from a first set of configuration data of the semiconductor device stored in a non-volatile one-time programmable, OTP, memory of the semiconductor device, generate a completion signal for causing a readiness signal to be asserted to enable one or more functional components of the semiconductor device to access the modified working copy.

An example (e.g., example 68) relates to a device comprising means for processing for during a cold boot sequence of the semiconductor device receiving one or more machine-readable descriptors, which are generated based on a second set of configuration data of the semiconductor device stored in a non-volatile rewritable memory of the semiconductor device, performing a read-modify-write operation on a working copy of configuration values stored in a volatile memory of the semiconductor device based on patch data included in the one or more descriptors, wherein the working copy is initially loaded with values from a first set of configuration data of the semiconductor device stored in a non-volatile one-time programmable, OTP, memory of the semiconductor device, generating a completion signal for causing a readiness signal to be asserted to enable one or more functional components of the semiconductor device to access the modified working copy.

Another example (e.g., example 69) relates to a computer program having a program code for performing the method of any one of examples 57 to 65 when the computer program is executed on a computer, a processor, or a programmable hardware component.

An example (e.g., example 70) relates to a method for performing a warm reset exit on a semiconductor device, the method comprising in response to receiving an indication of a warm reset exit of the semiconductor device validating an integrity of a working copy of configuration values retained in a volatile memory within an always-on, AON, power domain of the semiconductor device, wherein the working copy was previously patched based on a second set of configuration data during a prior cold boot sequence, upon successful validation of the retained working copy causing a readiness signal to be asserted to enable one or more functional components of the semiconductor device to access the retained working copy without re-patching from the second set of configuration data, and upon failing of the validation of the retained working copy initiating a recovery sequence comprising a re-sensing of configuration data from a non-volatile one-time programmable, OTP, memory.

Another example (e.g., example 71) relates to a previous example (e.g., example 70) or to any other example, further comprising that the working copy retained in the volatile memory was initially loaded with values from a first set of configuration data, the first set comprising at least one parameter selected from a group consisting of a device identifier, a maximum hardware operational frequency, a maximum operational voltage, and a maximum thermal threshold.

Another example (e.g., example 72) relates to a previous example (e.g., one of the examples 70 to 71) or to any other example, further comprising that the second set comprises at least one parameter selected from a group consisting of a product-specific operational frequency, a power budget, a number of enabled processing cores, a feature enablement flag, and an export-control parameter.

Another example (e.g., example 73) relates to a previous example (e.g., one of the examples 70 to 72) or to any other example, further comprising that validating the integrity of the working copy comprises performing at least one of a cyclic redundancy check, a version check, and an epoch check.

Another example (e.g., example 74) relates to a previous example (e.g., one of the examples 70 to 73) or to any other example, further comprising that the recovery sequence initiated upon the validation failing comprises instructing a re-patching of the working copy based on the second set of configuration data.

Another example (e.g., example 75) relates to a previous example (e.g., one of the examples 70 to 74) or to any other example, further comprising that causing the readiness signal to be asserted comprises re-exposing one or more latched registers to the one or more functional components.

Another example (e.g., example 76) relates to a previous example (e.g., one of the examples 70 to 75) or to any other example, further comprising that the readiness signal comprises a gating bit that acts as a barrier to prevent the one or more functional components from accessing the working copy prior to the successful validation.

An example (e.g., example 77) relates to a non-transitory computer-readable medium storing instructions that, when executed by a processing circuitry, cause the processing circuitry to perform a method for a warm reset exit on a semiconductor device, the method comprising in response to receiving an indication of a warm reset exit of the semiconductor device validating an integrity of a working copy of configuration values retained in a volatile memory within an always-on, AON, power domain of the semiconductor device, wherein the working copy was previously patched based on a second set of configuration data during a prior cold boot sequence, upon successful validation of the retained working copy causing a readiness signal to be asserted to enable one or more functional components of the semiconductor device to access the retained working copy without re-patching from the second set of configuration data, and upon failing of the validation of the retained working copy initiating a recovery sequence comprising a re-sensing of configuration data from a non-volatile one-time programmable, OTP, memory.

An example (e.g., example 78) relates to an apparatus comprising a processor circuitry configured to in response to receiving an indication of a warm reset exit of the semiconductor device validate an integrity of a working copy of configuration values retained in a volatile memory within an always-on, AON, power domain of the semiconductor device, wherein the working copy was previously patched based on a second set of configuration data during a prior cold boot sequence, upon successful validation of the retained working copy cause a readiness signal to be asserted to enable one or more functional components of the semiconductor device to access the retained working copy without re-patching from the second set of configuration data, and upon failing of the validation of the retained working copy initiate a recovery sequence comprising a re-sensing of configuration data from a non-volatile one-time programmable, OTP, memory.

An example (e.g., example 79) relates to a device comprising means for processing for in response to receiving an indication of a warm reset exit of the semiconductor device validating an integrity of a working copy of configuration values retained in a volatile memory within an always-on, AON, power domain of the semiconductor device, wherein the working copy was previously patched based on a second set of configuration data during a prior cold boot sequence, upon successful validation of the retained working copy causing a readiness signal to be asserted to enable one or more functional components of the semiconductor device to access the retained working copy without re-patching from the second set of configuration data, and upon failing of the validation of the retained working copy initiating a recovery sequence comprising a re-sensing of configuration data from a non-volatile one-time programmable, OTP, memory.

Another example (e.g., example 80) relates to a computer program having a program code for performing the method of any one of examples 70 to 76 when the computer program is executed on a computer, a processor, or a programmable hardware component.

Another example (e.g., example 81) relates to a machine-readable storage including machine readable instructions, when executed, to implement a method or realize an apparatus as claimed in any pending claim.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor-or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory computer-readable medium storing instructions that, when executed by a processing circuitry, causing the processing circuitry to perform a method comprising: receiving configuration inputs for a target semiconductor device, the configuration inputs comprising a device identifier, one or more safety-critical parameters, and profile-specific operational parameters for one or more semiconductor device configuration profiles; and
generating a first set of configuration data for programming into a non-volatile one-time programmable, OTP, memory of the target semiconductor device, the first set of configuration data comprising the safety-critical parameters and the device identifier; and
generating a second set of configuration data for a non-volatile rewritable memory of the target semiconductor device, the second set of configuration data comprising the profile-specific operational parameters for a specific device configuration profile, a cryptographic signature and a manifest, wherein the manifest is configured to bind the second set of configuration data to the device identifier and to enforce immutability of the second set of configuration data upon the target semiconductor device reaching a predefined lifecycle state 2. The non-transitory computer-readable medium of claim 1, wherein the cryptographic signature is calculated based on at least the profile-specific operational parameters or the manifest.

3. The non-transitory computer-readable medium of claim 1, wherein the device identifier is a hardware-based unique identifier comprising at least one of a PCIe device identifier, a fused serial number, a Media Access Control, MAC, address, or an identifier derived from a Physical Unclonable Function, PUF.

4. The non-transitory computer-readable medium of claim 1, wherein the method further comprises: transmitting the generated first set of configuration data to a programming interface for the non-volatile OTP memory; and
transmitting the generated second set of configuration data to a programming interface for the non-volatile rewritable memory.

5. The non-transitory computer-readable medium of claim 1, wherein the second set of configuration data is redundantly stored across a plurality of logical boot partitions on the non-volatile rewritable memory.

6. The non-transitory computer-readable medium of claim 1, wherein the safety-critical parameters comprise at least one of a maximum hardware operational frequency, a maximum operational voltage, a maximum thermal threshold or permanent disablement data for one or more hardware blocks.

7. The non-transitory computer-readable medium of claim 1, wherein the profile-specific operational parameters comprise at least one of a product-specific operational frequency that is constrained by a corresponding safety-critical maximum hardware operational frequency, a power budget, a number of enabled processing cores or execution units, a feature enablement flag or export-control parameter.

8. The non-transitory computer-readable medium of claim 1, wherein the configuration inputs further comprise system-level operational parameters, and wherein the method further comprises integrating the system-level operational parameters into the second set of configuration data.

9. The non-transitory computer-readable medium of claim 1, wherein the second set of configuration data is structured to include scatter-gather descriptors for use by a direct memory access, DMA, engine on the target semiconductor device.

10. The non-transitory computer-readable medium of claim 1, wherein target semiconductor device comprises at least one of a System-on-a-Chip, SoC, a discrete graphics processing unit, dGPU, a central processing unit, CPU, or an accelerator.

11. An apparatus storing configuration data of a target semiconductor device, comprising:
a non-volatile one-time programmable, OTP, memory storing a first set of configuration data for the target semiconductor device, the first set of configuration data comprising a device identifier and safety-critical parameters; and
a non-volatile rewritable memory storing a second set of configuration data for the target semiconductor device, the second set of configuration data comprising profile-specific operational parameters, a cryptographic signature, and a manifest, wherein the manifest is configured to bind the second set of configuration data to the device identifier and to enforce immutability of the second set of configuration data upon the system reaching a predefined lifecycle state.

12. The apparatus of claim 11, wherein the second set of configuration data is redundantly stored across a plurality of logical boot partitions on the non-volatile rewritable memory.

13. The apparatus of claim 11, wherein the device identifier stored in the OTP memory is a hardware-based unique identifier comprising at least one of a PCIe device identifier, a fused serial number, a Media Access Control, MAC, address, or an identifier derived from a Physical Unclonable Function, PUF.

14. The apparatus of claim 11, further comprising a direct memory access DMA engine, wherein the DMA is configured to use scatter-gather descriptors included in the second set of configuration data to patch a working copy of configuration values in a volatile memory.

15. An apparatus for performing a cold boot sequence on a semiconductor device comprising interface circuitry, machine-readable instructions and processing circuitry to execute the machine-readable instructions to
during a cold boot sequence of the semiconductor device:
receive one or more machine-readable descriptors, which are generated based on a second set of configuration data of the semiconductor device stored in a non-volatile rewritable memory of the semiconductor device;
perform a read-modify-write operation on a working copy of configuration values stored in a volatile memory of the semiconductor device based on patch data included in the one or more descriptors,
wherein the working copy is initially loaded with values from a first set of configuration data of the semiconductor device stored in a non-volatile one-time programmable, OTP, memory of the semiconductor device;
generate a completion signal for causing a readiness signal to be asserted to enable one or more functional components of the semiconductor device to access the modified working copy.

16. The apparatus of claim 15, wherein the processing circuitry comprises a scatter-gather direct memory access, SG-DMA, engine, and wherein the SG-DMA engine is configured to perform the read-modify-write operation.

17. The apparatus of claim 15, wherein the one or more machine-readable descriptors comprise at least one of a physical address in the volatile memory, a data mask, or a data length.

18. The apparatus of claim 15, wherein the read-modify-write operation is configured to write the modified one or more configuration values to a plurality of disaggregated memory locations within the volatile memory to reduce fabric congestion.

19. The apparatus of claim 15, wherein the apparatus receives the one or more machine-readable descriptors from a trusted firmware agent executing on a controller of the semiconductor device.

20. The apparatus of claim 15, wherein the patch data included in the one or more descriptors comprises profile-specific operational parameters derived from the second set of configuration data.
upon failing of the validation of the retained working copy initiate a recovery sequence comprising a re-sensing of configuration data from a non-volatile one-time programmable, OTP, memory.
